(19) United States
(12) Patent Application Publication
(10) Pub. No.: US 2026/0115938 A1
(43) Pub. Date: Apr. 30, 2026

(54) MECHANICAL METACAPS FOR FAST-RESPONSIVE, TUNABLE AND MULTIFUNCTIONAL SOFT ROBOTS

(71) Applicant: THE TRUSTEES OF THE UNIVERSITY OF PENNSYLVANIA, Philadelphia, PA (US)

(72) Inventors: Shu YANG, Blue Bell, PA (US); Lishuai JIN, Philadelphia, PA (US)

(21) Appl. No.: 19/118,512

(22) PCT Filed: Oct. 11, 2023
(86) PCT No.: PCT/US2023/076584

§ 371 Date: Apr. 4, 2025

Related U.S. Application Data
(60) Provisional application No. 63/379,008, filed on Oct. 11, 2022.

(51) Int. Cl. B25J 15/12; B25J 15/00; B25J 15/10

(52) U.S. Cl. CPC B25J 15/12; B25J 15/0023; B25J 15/10

(57) ABSTRACT

A component, comprising: a cap, the cap optionally being a spherical cap, the cap having a first surface and a second surface, the cap being reversibly convertible between (i) a first state in which the first surface is concave and the second surface is convex and (ii) a second state in which the first surface is convex and the second surface is concave, at least one of the first state and the second state being a stable state, the cap defining a center, the first surface comprising a plurality of radially-extending ribs extending outwardly from a central axis that extends from the center of the cap and orthogonal to the first surface, a radially extending rib having an end at a radial distance from the center, a radially-extending rib being optionally being substantially sector-shaped in configuration and widening as measured in a radial direction away from the center, the first surface further comprising a circumferentially extending rib.

### RELATED APPLICATIONS

The present application claims priority to and the benefit of U.S. patent application No. 63/379,008, “Mechanical Metacaps For Fast-Responsive, Tunable And Multifunctional Soft Robots” (filed Oct. 11, 2022). All foregoing applications are incorporated herein by reference in their entireties for any and all purposes.

### GOVERNMENT RIGHTS

This invention was made with government support under W911-NF-1810327 awarded by the United States Army. The government has certain rights in the invention.

### TECHNICAL FIELD

The present disclosure relates to the field of soft robotics.

### BACKGROUND

Over the past decades, there have been considerable development in soft robots that bridges the gap between conventional machines with high performance but rigid components and biological organisms with remarkable versatility and adaptability. The merits of soft robots are generally accomplished by deforming partial or all of the compliant robotic bodies via approaches such as pneumatic and hydraulic actuation, thermal stimulation, (12, 13), swelling (14, 15), magnetic and electric activation (16-18). The deformation mechanism can be roughly classified into two types: one deforms with a rate monotonically related to the input energy, yet its performance is limited by the power and capacity of the input; the other exploits the elastic structural instabilities to uncouple the input and output by gradually storing elastic energy before releasing it suddenly (19-24). The latter is ideal for applications requiring high-rate motion and fast energy release.

Spherical caps, exhibiting snap-through response when turned “inside-out”, are one structure for the design of rapidly responsive robots (25, 26). But the performance of these robotic systems is restricted by certain properties of the caps. For instance, a simple spherical cap with uniform thickness and clamped border is typically monostable, and they are extremely sensitive to imperfections when the thickness-to-radius ratio is small, leading to asymmetric deformation modes and limited energy release upon snapping (see FIG. 1A and the corresponding pressure-volume curve in FIG. 1D). When increasing the thickness-to-radius ratio can enhance the cap robustness, it also compromises the snapping behaviors (see FIG. 1B and the corresponding pressure-volume curve in FIG. 1D). Accordingly, there is a long-felt need in the art for improved soft robotic components.

### SUMMARY

Soft robots have great potentials in myriad scenarios because of their intrinsically compliant bodies, enabling safe interactions with human and adaptability to unpredictable environments. However, most of them have limited actuation speeds, and require complex control systems, yet are lack of sensing capability. To address these challenges, provided here is a class of metacaps whose rich nonlinear mechanical behaviors can be harnessed to produce soft robots with unprecedented functionalities. As an illustrative, non-limiting example, we demonstrate a sensor-less gripper that can grasp objects in 3.75 ms upon physical contact, and a pneumatically actuated gripper with tunable actuation behaviors that has little dependence on the rate of input. Both grippers can be readily integrated into a robotic platform for practical applications. Moreover, the metacap enables propelling of a swimming robot, exhibiting amplified swimming speed as well as untethered, electronics-free swimming with tunable speeds. The disclosed metacaps have applicability in a number of fields, including to the next generation of soft robots requiring high transient output energy and capable of autonomous and electronics-free.

In meeting the described long-felt needs, the present disclosure provides a component, comprising: a cap, the cap optionally being a spherical cap, the cap having a first surface and a second surface, the cap being reversibly convertible between (i) a first state in which the first surface is concave and the second surface is convex and (ii) a second state in which the first surface is convex and the second surface is concave, at least one of the first state and the second state being a stable state, the cap defining a center, the first surface comprising a plurality of radially-extending ribs extending outwardly from a central axis that extends from the center of the cap and orthogonal to the first surface, a radially extending rib having an end at a radial distance from the center, a radially-extending rib being optionally being substantially sector-shaped in configuration and widening as measured in a radial direction away from the center, the first surface further comprising a circumferentially extending rib.

Also provided is a system, comprising: a component according to the present disclosure (e.g., according to any one of Aspects 1-11); and a force applicator configured to exert a positive pressure or a negative pressure against the second surface of the cap so as to encourage the cap from one of the first state and the second state toward the other of the first state and the second state.

Also provided is a method, comprising: with a component according to the present disclosure (e.g., according to any one of Aspects 1-11), exerting a positive pressure or a negative pressure against the second surface of the cap so as to encourage the cap from one of the first state and the second state toward the other of the first state and the second state.

### BRIEF DESCRIPTION OF THE DRAWINGS

In the drawings, which are not necessarily drawn to scale, like numerals may describe similar components in different views. Like numerals having different letter suffixes may represent different instances of similar components. The drawings illustrate generally, by way of example, but not by way of limitation, various aspects discussed in the present document. In the drawings:

FIG. 1. Design and characterization of the metacaps. (A) A spherical cap with low thickness-to-radius ratio exhibits an asymmetric snapping instability when inflated. (B) A thick cap of the same radius is more robust showing a symmetric deformation mode but lacking in snapping. (C) A metacap with architected structures, whose mechanical behaviors can be regulated by the geometries of the ribs. (D) The pressure-volume curves, normalized by initial shear modulus, p, and radius, R, of the thin cap (t₁/R=0.075, grey line), thick cap (t₂/R=0.15, green line) and metacap (t/R=0.075, φₒ=5.0°, φ_{c}=8.0°, t_{c}/R=0.133, φᵣ=47.85°, θᵣ=35.0°, tᵣ/R=0.267, red line). (E) Evolution of the elastic energy as a function of the volume change for different caps. The inset shows the hysteresis of the thin cap upon inflation and deflation. (F) Landscape of the energy release Eᵣ upon deflation as a function of tᵣ and t_{c}. (G) Landscape of the energy barrier E_{b} upon deflation as a function of tᵣ and t_{c}.

FIG. 2. Passive metacap grippers. (A) Schematics of the passive gripper that closes upon applying a certain force at the center of the cap. The cap is fixed by two acrylic plates through four bolts, and four 3D printed fingers (ABS) are glued on the ribs of the cap to catch the objects. (B) The grippers can grasp objects of different shapes, moduli and weights. (C) The gripper is capable of realizing highly dynamic grasping tasks. A ball hits at the center of the cap with a speed around 5.8 m/s is caught by the gripper in 3.75 ms. (D) Integration of the gripper to a baseball glove facilitates the grasping of the baseball. (E,F) The metacap gripper is integrated into a robotic arm (Franka Emika Panda) and controlled by a linear actuator (USLICCX LA-T8) for open, and the close is fully passive.

FIG. 3. Pneumatically actuated grippers with tunable speed. (A) An experimental snapshot of the actuator. The metacap gripper is clamped to an acrylic chamber whose volume is tunable by changing the position of the 3D printed piston. (B) Experimental snapshots of the opening process of grippers with different initial volumes. The one with V₀=10 mL takes 500 ms to deform from the closed state to the open state, while the one with V₀=90 mL needs 6.75 ms to snap open, indicating that actuation speeds can be tuned by the initial volume of the chamber. (C) Schematic of the pneumatically actuated gripper before and after snapping. P_{c} and V_{c} are the critical pressure and volume inside the chamber before the metacap snaps. Pₜ and Vₜ represents the current pressure and volume after the metacap snaps. (D) The energy release from compressed air during the snapping process can be calculated from the pressure-volume curve of the metacap via the Boyle's law. (E) Evolution of the strain energy of the metacap as a function of volume change. When the initial volume V₀=10 mL, the metacap releases 19.3 mJ energy during the snapping, while absorbing 10.3 mJ energy when V₀=90 mL. (F) Evolution of the total energy release and the maximum speed of the gripper as a function of the initial volume V₀. (G) Experimental snapshots of the metacap gripper with V₀=10 mL, taking 750 ms to grasp a strawberry gently. (H) Experimental snapshots of the metacap gripper with V₀=90 mL, taking 8.3 ms to grab a plastic ball. (I) Comparison of the actuation speed and dimension from our metacap grippers vs. those from the soft actuators reported in literature based on pneumatic actuation (21, 35-38), swelling (14), application of electric field (39-41) and magnetic field (42), and thermal activation (43, 44). Our grippers exhibit the fastest actuation speed while also tunable for multipurpose applications.

FIG. 4. The metacap enabled swimming robot with amplified swimming speed. (A) An experimental snapshot of the swimming robot comprising a 3D printed body, a metacap and a bending actuator that controls the movement of the fins. (B) Schematic of the mechanism of the swimming robot. (C) Pressure-volume curves of the metacap with and without coupling. (D) Pressure-volume curves of the bending actuator with and without coupling. (E) The landscape of energy release from the bending actuator for a stroke as a function of the thickness of t_{c} and tᵣ. (F) Experimental snapshots of the swimming robots with and without the metacap, both of them are supplied with the same pneumatic input. Scale bar, 10 cm. (G) Comparison of the instantaneous velocity between these two robots together with the profile of the input volume.

FIG. 5. Oscillating valves enable untethered and electronics-free swimming robots. (A) An experimental snapshot of the untethered and electronics-free swimming robot. (B) Design and working mechanism of the oscillating valve. The valve comprises a monostable metacap with an aperture at the center of the cap and a TPU membrane. (C) Experimental setup for characterizing the oscillating valve. (D) Various pressure profiles obtained from varying the input flow rate of the valve. (E) Experimental comparison of the swimming speed for robots with different stroke frequencies. Scale bar, 10 cm. (F) Experimental snapshots of the robot tested in a swimming pool. The robots can across the diagonal of the swimming pool (˜6 m*6 m) in 40 s.

FIG. 6. Fabrication of the metacap grippers. Snapshots of 6 steps used to fabricate the passive gripper. Scale bars, 30 mm.

FIG. 7. Fabrication of the passive grippers. Snapshots of the 3 steps used to fabricate the passive gripper. Scale bars, 30 mm.

FIG. 8. Fabrication and operation of the baseball glove with Integrated metacap gripper. Snapshots of the 6 steps used to fabricate and operate the baseball glove. Scale bars, 30 mm.

FIG. 9. Fabrication of the pneumatic grippers. Snapshots of the 3 steps used to fabricate the pneumatic gripper. Scale bars, 30 mm.

FIG. 10. Fabrication of the bending actuators. Snapshots of the 6 steps used to fabricate the bending actuators. Scale bars, 20 mm.

FIG. 11. Geometry of the bending actuator. (A) Geometry of the external frame. (B) Geometry of the internal frame. Unit: mm.

FIG. 12. Fabrication of the oscillating valve. Snapshots of the 5 steps used to fabricate the oscillating valve. Scale bars, 30 mm.

FIG. 13. Fabrication of the untethered and electronics-tree swimming robot. Snapshots of the 4 steps used to fabricate the swimming robot. Scale bars, 30 mm.

FIG. 14. Comparisons of the uniaxial tensile stress-strain curves between the experimental results (solid lines) and theoretical predictions from the Gent model (dashed line). (A) The mechanical response of Elite Double 32 is accurately captured using μ=0.36 MPa and Jₘ=11.2. (B) The mechanical response of Flex 80 is accurately predicted using μ=1.55 MPa and Jₘ=5.0.

FIG. 15. Experimental validation on the mechanical behavior of the metacap. (A) Schematic of the experimental setup to characterize the pressure-volume relations of metacaps. (1) Syringe pump based on a linear translation stage (LT800, Thorlabs). (2) Pressure sensor (ELVH-0150, All Sensors). (3) Water tank. (4) Metacap mounted on a chamber. (B) Comparison between experimental (continuous lines) and numerical (dashed line) results on the pressure evolution inside the chamber of the metacap.

FIG. 16. Experimental setup for characterization of the oscillating valve. We supply the valve with a constant pressure input (˜50 kPa) and measure the pressure profile in the chamber using a pressure sensor (ELVH-015D, All Sensors).

FIG. 17. Effect of the geometry of the TPE membrane on the mechanical response of the oscillating valve. (A) The pressure profile corresponding to the lowest oscillating frequency of the valve with w=7 mm. (B) The pressure profile corresponding to the highest oscillating frequency of the valve with w=5 mm. (C) The upper and lower limits of the oscillating frequency with varied width of the membrane.

FIG. 18. Experimental characterization of the bending actuator. (A, B) Experimental snapshots of the bending actuator at the (A) closed and (B) open states. (C) Evolution of the pressure as a function of the volume change for the bending actuator upon inflation and deflation, showing a hysteresis loop.

FIG. 19. FE simulations of the metacap. (A) Boundary conditions of the metacap simulations. (B) Stress distributions in the metacap (with tᵣ=10 mm, t_{c}=6 mm, Elite Double 32) before and after snapping. Unit: MPa.

FIG. 20. Our metacap grippers are capable of grasping objects with a wide range of shapes, moduli and weights. (A,B) The gripper made of Ecoflex 00-50 (Smooth-On Inc.) can grasp soft and delicate fruits like strawberries and grapes. (C,D) The gripper made of Elite Double 32 can capture objects of cuboid and conical shapes tightly. Scale bar, 30 mm.

FIG. 21. Experimental measurements of the actuation speed of the passive gripper. The passive gripper made of Elite Double 32 can capture a stress ball within 8.5 ms after it hits on the center of the metacap. Scale bar, 30 mm.

FIG. 22. Our metacap gripper can mimic the a squirrel's paw when landing on a rod. (A) Squirrels can leap from one tree branch to another quickly and stably. In our experiments, the front paw of a squirrel takes 10 ms to grasp on a rod after making contact with the rod. (B,C) The grippers made of (B) Elite Double 32 and (C) Flex 80 can grab the rod in 12 ms and 6.25 ms, respectively, after making contact to the rod. The modulus of the metacap shows a large effect on the actuation speed of the gripper. The tests of the grippers are filmed with a high-speed camera (FASTCAM SA1.1, Photron) with 4000 frames per second (fps) to record the dynamic behaviors. Scale bar, 30 mm.

FIG. 23. Experimental snapshots of the opening and closing processes for the pneumatic actuators with different Initial volumes. (A) When the initial volume V₀=10 ml, the actuator takes 500 ms to open and 480 ms to close. (B) When the initial volume V₀=50 ml, the actuator takes 10.50 ms to open and 11.50 ms to close. (C) It only takes 6.75 ms for the actuator to open and 7.50 ms to close when V₀=90 ml. All actuators are inflated/deflated using the same pump (TSC JSB1523006) and the tests are filmed with a high-speed camera (FASTCAM SAL.1, Photron) to record the dynamic behavior. The frame rate of the camera is 1000, 2000 and 4000 frames per second (fps) for tests of V₀=10 ml, V₀=50 ml and V₀=90 ml, respectively. Scale bar, 30 mm.

FIG. 24. Model for the Closing process of the pneumatic gripper. (A) Pressure-volume curves of the metacap upon Inflation and deflation. During the closing process, the air inside the chamber absorbs energy (ΔEₐᵢᵣ=−20.2 mJ), which can be calculated from the area of the red shaded region. (B) The evolution of elastic energy as a function of the volume change Inside the chamber. The metacap release (ΔE_{cap}=130.7 mJ) elastic energy during the closing. (C) The total energy release versus the initial cavity of the chamber for the closing process of the gripper. Higher energy is released with larger V₀, which is experimentally validated by measuring the maximum speed of the finger tips.

FIG. 25 provides a non-limiting depiction of various applications for the disclosed metacaps. As shown, a metacap can be used as a passive gripper, as an actuator that can also have a tunable actuation speed, and can also be used to regulate the response of other actuators.

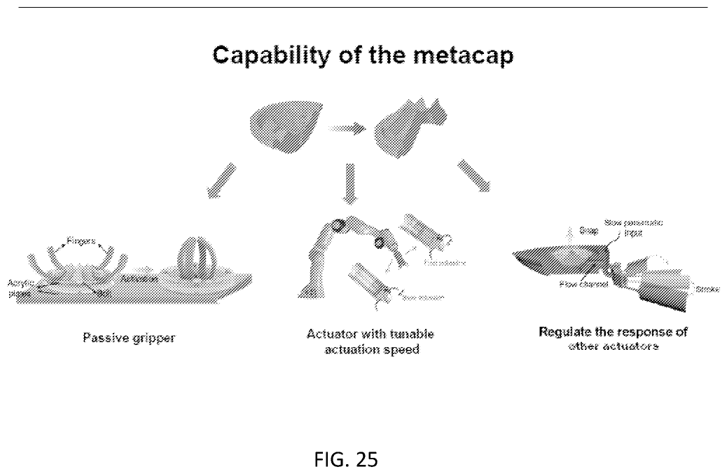

FIG. 26 provides a non-limiting illustration of the tunable actuation speed for the opening of a metacap according to the present disclosure.

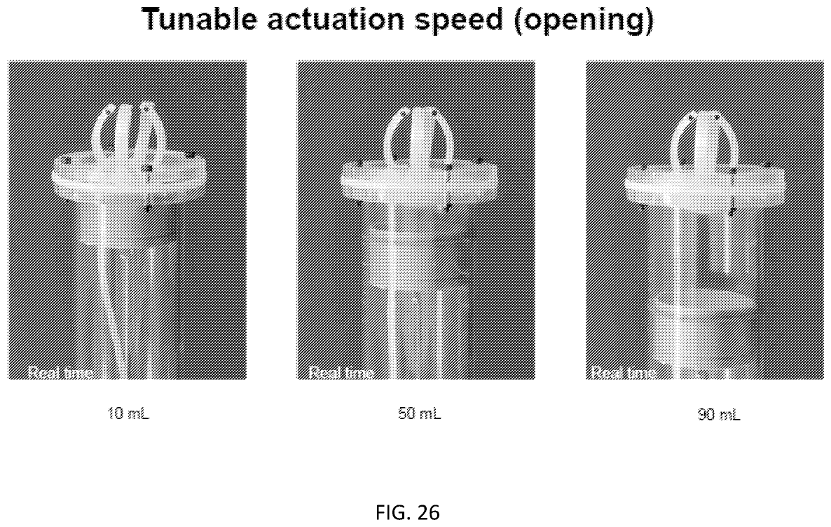

FIG. 27 provides a non-limiting illustration of the tunable actuation speed for the closing of a metacap according to the present disclosure.

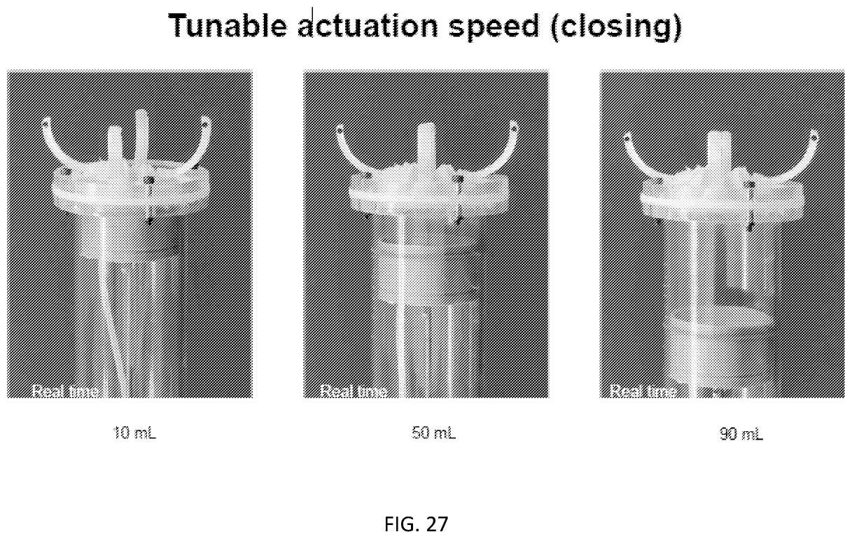

### DETAILED DESCRIPTION OF ILLUSTRATIVE EMBODIMENTS

The present disclosure may be understood more readily by reference to the following detailed description of desired embodiments and the examples included therein.

Unless otherwise defined, all technical and scientific terms used herein have the same meaning as commonly understood by one of ordinary skill in the art. In case of conflict, the present document, including definitions, will control. Preferred methods and materials are described below, although methods and materials similar or equivalent to those described herein can be used in practice or testing. All publications, patent applications, patents and other references mentioned herein are incorporated by reference in their entirety. The materials, methods, and examples disclosed herein are illustrative only and not intended to be limiting.

The singular forms “a,” “an,” and “the” include plural referents unless the context clearly dictates otherwise.

As used in the specification and in the claims, the term “comprising” can include the embodiments “consisting of” and “consisting essentially of.” The terms “comprise(s),” “include(s),” “having,” “has,” “can,” “contain(s),” and variants thereof, as used herein, are intended to be open-ended transitional phrases, terms, or words that require the presence of the named ingredients/steps and permit the presence of other ingredients/steps. However, such description should be construed as also describing compositions or processes as “consisting of” and “consisting essentially of” the enumerated ingredients/steps, which allows the presence of only the named ingredients/steps, along with any impurities that might result therefrom, and excludes other ingredients/steps.

As used herein, the terms “about” and “at or about” mean that the amount or value in question can be the value designated some other value approximately or about the same. It is generally understood, as used herein, that it is the nominal value indicated ±10% variation unless otherwise indicated or inferred. The term is intended to convey that similar values promote equivalent results or effects recited in the claims. That is, it is understood that amounts, sizes, formulations, parameters, and other quantities and characteristics are not and need not be exact, but can be approximate and/or larger or smaller, as desired, reflecting tolerances, conversion factors, rounding off, measurement error and the like, and other factors known to those of skill in the art. In general, an amount, size, formulation, parameter or other quantity or characteristic is “about” or “approximate” whether or not expressly stated to be such. It is understood that where “about” is used before a quantitative value, the parameter also includes the specific quantitative value itself, unless specifically stated otherwise.

Unless indicated to the contrary, the numerical values should be understood to include numerical values which are the same when reduced to the same number of significant figures and numerical values which differ from the stated value by less than the experimental error of conventional measurement technique of the type described in the present application to determine the value.

All ranges disclosed herein are inclusive of the recited endpoint and independently of the endpoints. The endpoints of the ranges and any values disclosed herein are not limited to the precise range or value; they are sufficiently imprecise to include values approximating these ranges and/or values.

As used herein, approximating language can be applied to modify any quantitative representation that can vary without resulting in a change in the basic function to which it is related. Accordingly, a value modified by a term or terms, such as “about” and “substantially,” may not be limited to the precise value specified, in some cases. In at least some instances, the approximating language can correspond to the precision of an instrument for measuring the value. The modifier “about” should also be considered as disclosing the range defined by the absolute values of the two endpoints. For example, the expression “from about 2 to about 4” also discloses the range “from 2 to 4.” The term “about” can refer to plus or minus 10% of the indicated number. For example, “about 10%” can indicate a range of 9% to 11%, and “about 1” can mean from 0.9-1.1. Other meanings of “about” can be apparent from the context, such as rounding off, so, for example “about 1” can also mean from 0.5 to 1.4. Further, the term “comprising” should be understood as having its open-ended meaning of “including,” but the term also includes the closed meaning of the term “consisting.” For example, a composition that comprises components A and B can be a composition that includes A, B, and other components, but can also be a composition made of A and B only. Any documents cited herein are incorporated by reference in their entireties for any and all purposes.

Mechanical metamaterials, whose properties are determined by not only the constituent materials but also the architected geometries at micro/macro scale, offer a new paradigm to realize extraordinary snap-through behaviors and tunable stabilities by leveraging geometric constraints for potential applications of “smart” purposes such as energy absorption (27, 28), biomedical devices (29, 30), and soft robotics (31, 32).

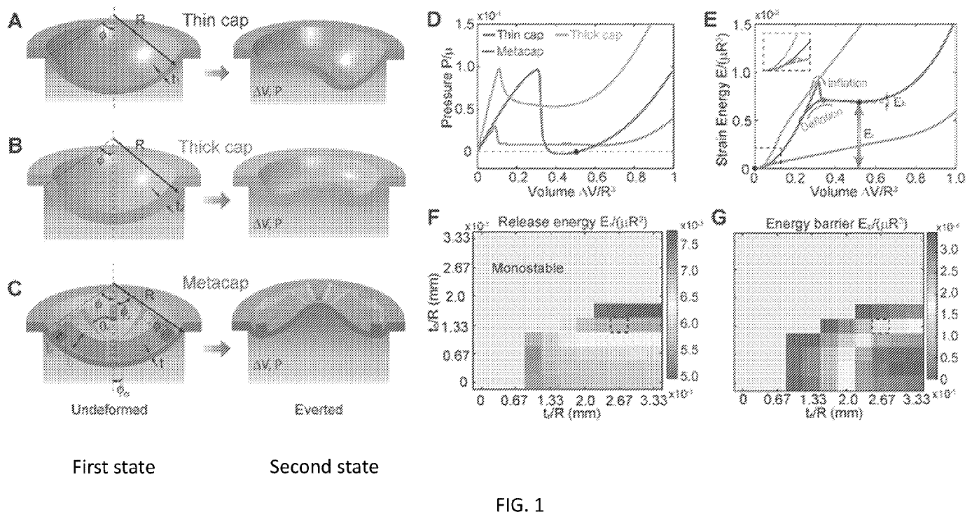

Here, we design a class of metacaps, whose snapping behaviors can be tailored to address the current challenges in soft robots. The geometry of the metacap comprises a spherical cap patterned with an array of ribs aligned in the circumferential and radial directions of the cap (FIG. 1C). By rationally tailoring the geometry of the ribs, we can realize rich nonlinear mechanical properties of the caps, enabling a variety of soft robotic systems with unprecedented functionalities, including (i) a passive metacap gripper with mechanically embedded sensing capable of grasping objects in 3.75 ms upon contact; (ii) a pneumatically actuated metacap gripper with tunable actuation speed that is independent of the input rate but readily tunable by changing the volume of the chamber that is connected to the gripper; (iii) a swimming robot whose speed is amplified by the metacap, which can be actuated untethered and electronics-free.

To realize highly robust, bistable and fast snap-through behaviors, we design the metacap by introducing an array of ribs to a simple spherical cap of radius, R, thickness, t, and polar angle, φ. The array contains 8 radial ribs (with thickness, tᵣ, polar angle, φᵣ and azimuthal angle, θᵣ, in FIG. 1C) and one circumferential rib (the red rib with thickness, t_{c}, polar angle, φ_{c}). As the ribs affect the bending stiffness of the cap locally, the mechanical response of the metacaps can be significantly different from that of spherical caps with uniform thickness.

First, we conduct finite element (FE) analyses to investigate the response of caps with variable geometries upon pressurization. FIG. 1D compares the pressure-volume curves of three caps, including the thin cap with t₁/R=0.075, the thick cap with t₂/R=0.15, and the metacap with t/R=0.075, #ₒ=5.0°, t_{c}=8.0°, t_{c}/R=0.2, φᵣ=47.85°, θᵣ=35.0° and tᵣ/R=0.33. All have the same polar angle φ=57.85°. Upon inflation, a sharp pressure drop inside the metacap is observed when the applied volume is larger than the critical one, that is the peak pressure of the curve, indicating a more pronounced snap-through behavior than that of spherical caps of various thicknesses. Moreover, the metacap can achieve a new equilibrium state after snapping, which is highlighted by the black dot in FIG. 1D. In contrast, conventional spherical caps with clamped boundaries are monostable upon inflation, regardless of the thickness and radius (33). FIG. 1E plots the evolution of the strain energy as a function of the volume change for the three caps. The inflation and deflation curves of the thick cap are identical, which increase monotonically as the applied volume increases. While the curves of the metacap and the thin cap show hysteresis between inflation and deflation due to the snap-through behavior. As expected, the thin cap has a monotonically decreased curve upon deflation, implying that the thin cap is monostable. In contrast, the deflation curve of the metacap is nonconvex, indicating the bistability of the metacap, which is useful for various robotic applications.

To get a better understanding on how the geometry of the rib affect the mechanical response of the metacap, we conduct a parametric study via FE simulations and report the landscape of the release energy, Eᵣ, when the cap deforms from the everted state to the undeformed state, and the energy barrier, E_{b}, which is used to trigger the transformation from the everted state to the undeformed state of the metacaps in FIGS. 1F and G, respectively. Throughout the study, we consider R=30 mm, φ=57.85°, t/R=0.075, φₒ=5.0°, φ_{c}=8.0°, φᵣ=47.85° and θᵣ=35.0° as fixed parameters and tune the response of the metacap by varying t_{c}/R∈[0-0.33] and tᵣ/R ∈[0-0.33]. From FIG. 1F, we find that the metacap is monostable when t_{c}/R≥0.2 or tᵣ/R≤0.067 (grey region in FIG. 1F). For a given tᵣ/R≥0.133, as the thickness of the circumferential ribs t_{c} increases, Eᵣ monotonically increases so that the release energy become larger and larger. While the effect of tᵣ on Eᵣ is less pronounced, characterized by little variation on Eᵣ when t_{c} is fixed. Differently, both tᵣ and t_{c} have significant impact on the energy barrier E_{b}, and smaller E_{b} can be achieved around the border between monostable and bistable regions, indicating that the metacaps from that region can be easily triggered to transform from the everted state to the undeformed state.

### Passive Metacap Grippers

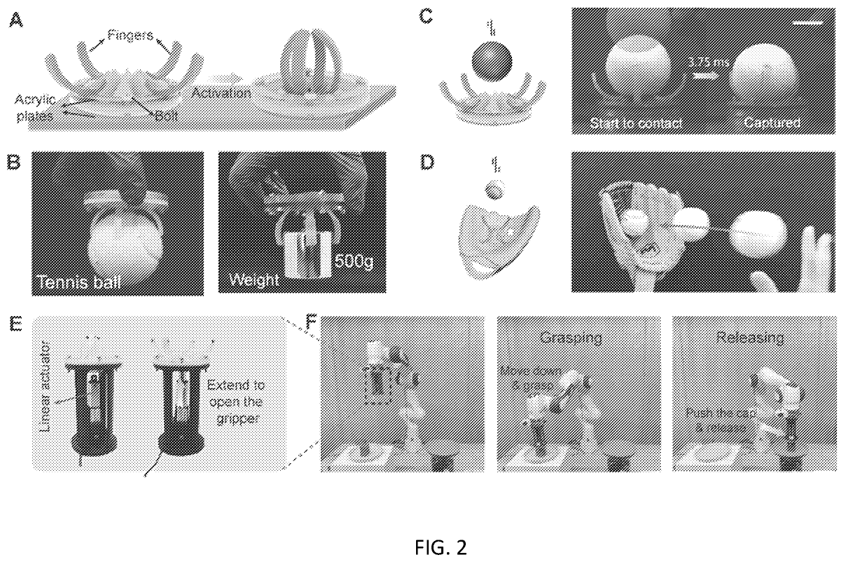

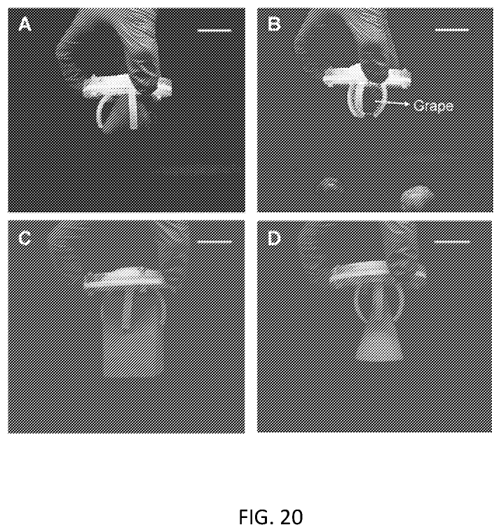

To test the mechanical behaviors of the metacap, we designed a passive gripper to grasp objects when a certain contact force is applied to the center of the metacap. The passive gripper comprises the bistable metacap, four fingers (3D printed from Acrylonitrile Butadiene Styrene, ABS) evenly glued on the radial ribs of the cap, and two acrylic plates fixed by four bolts to clamp the border of the metacap (see, e.g., FIG. 2A). By varying the geometry and material of the cap, we can adjust the stiffness of the gripper to grasp objects of different shapes, moduli and weights. FIG. 2B shows experimental snapshots of two grippers made of Elite Double 32 (with green color and initial shear modulus μ=0.36 MPa) and Flex 80 (with brown color and initial shear modulus μ=1.55 MPa) elastomers with the geometry highlighted in the dotted box in FIGS. 1F and G, grasping a tennis ball and a 500 g weight (around ten time of their self-weight), respectively. Note that the fingers of the Flex-80 gripper are coated with a thin layer of elastomer (Elite Double 22) to enhance the friction for more stabled grasping. Although the fingers are printed out of rigid ABS, the stiffness of the gripper and its response time is determined by the metacap itself instead of the fingers. More grasping tests on different objects can be found in FIG. 20.

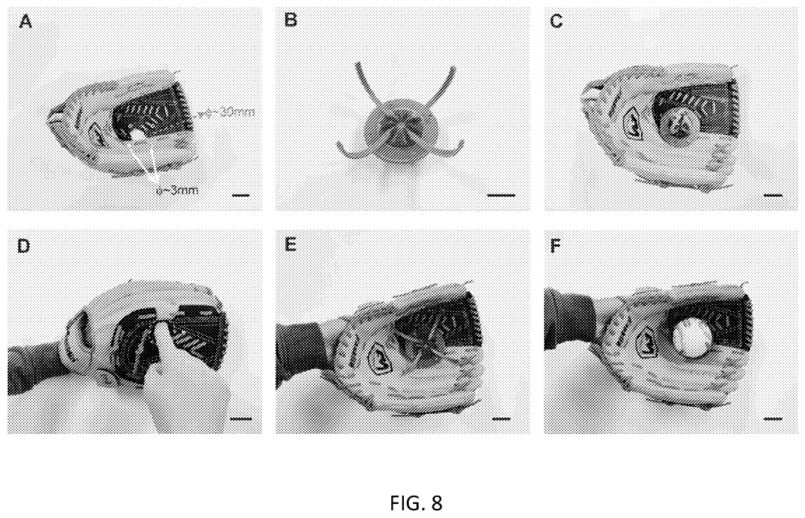

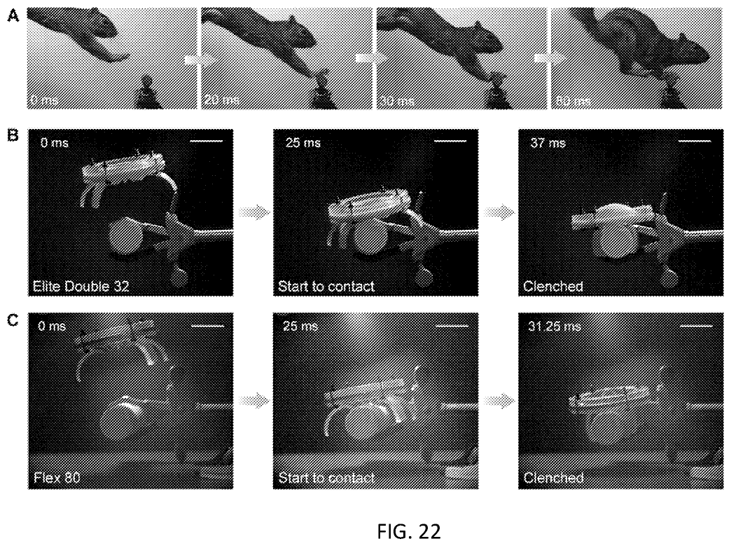

As the bistable metacap releases a large amount of elastic energy when the gripper deforms from the open to the closed state, the gripper is able to react rapidly and perform highly dynamic grasping tasks. FIG. 2C shows experimental snapshots of the metacap gripper made of Flex 80, grasping a stress ball in 3.75 ms after it hits the center of the metacap at a speed of ˜5.8 m/s. Accordingly, we can readily integrate the gripper to a baseball glove to facilitate the catching of baseballs (see snapshots in FIG. 2D). The grasping without using fingers will help practice of the hand movement and it will be especially beneficial for people with disability to play baseball (see fabrication of glove with gripper in FIG. 8). The rapid response of the metacap gripper also shows a great potential to mimic the landing behavior of squirrels when they leap from tree to tree (FIG. 22). Squirrels are known for their acrobatic maneuvers and capability of leaping through complex canopies to travel and avoid predators (34), which are ideal objects to emulate for high mobility robots. Our metacap gripper can mimic the landing behavior of squirrels' paws and facilitate the design of biomimetic robots with high agility.

Further, the simplicity of our metacap gripper make it readily integrated to an existing robotic platform for industrial applications. Towards this end, we clamp the gripper onto a 3D printed frame and mount a linear actuator (USLICCX LA-T8) at the center of the frame (FIG. 2E) to open the gripper by pushing the cap using the shaft of the linear actuator. Since the gripper is passive, it can grasp the object automatically when in contact with the object above a certain force. As seen in FIG. 2F, the objects can be grasped by the gripper when the robotic arm moves down and be released at the target position by pushing the metacap using the linear actuator.

Pneumatic Actuated Gripper with Tunable Actuation Speed

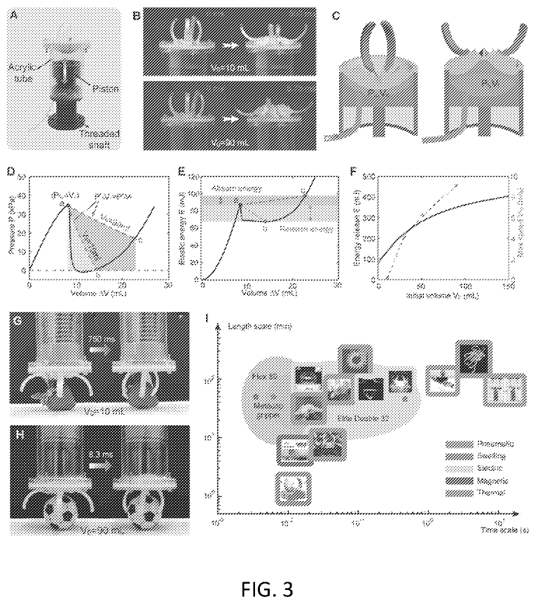

When the passive metacap gripper grasp objects rapidly, it also inflicts high impact onto the objects, which may cause undesirable damages to the objects, especially the soft and delicate ones such as fruits and eggs. To extend the capability and adaptiveness of our grippers, we design a pneumatic actuation mechanism (FIG. 3A) where the actuation speed can be fine-tuned to allow for not only the rapid grasping for highly dynamic tasks but also the gentle manipulation for delicate objects. We clamp the metacap gripper to a chamber formed by an acrylic tube and a 3D-printed piston, whose volume can be adjusted by changing the position of the piston via twisting of the translational screw that connected to the piston (see Section 6.4 about the fabrication of the pneumatically actuated gripper). By leveraging the compressibility of the air and the bistability of the metacap, we achieve gentle actuation when the initial volume of the chamber V₀ is small (e.g. 10 mL in FIG. 3B) while realize rapid grasping when V₀ is large (e.g. 90 mL in FIG. 3B). The metacap is made of Elite Double 32 with the geometry highlighted in FIGS. 1F and G. It takes 500 ms for the gripper with V₀=10 mL to snap open when inflated using a pump (JSB1523006, TSC, China) at a flow rate of 2 mL/s, but 6.6 ms to snap open when V₀=90 mL with the same input.

To quantitatively understand the effect of V₀ on the actuation speed of the gripper under a constant pneumatic input, we develop a simple model to capture the energy release during the open and close of the gripper. We denote the critical pressure and the critical volume change that the cap snaps as P_{c} and ΔV_{c}, respectively, and the pressure and the volume change after the cap snaps as Pₜ and ΔVₜ, respectively (FIG. 3C). The actuation speed is determined by the amount of energy release during the snapping. We ignore the energy from the input, because the snapping is fast and the input flow rate is relatively slow. Therefore, the total energy release contains the elastic energy change from the metacap ΔE_{cap} and the compressed air ΔEₐᵢᵣ as

$$Δ E = Δ {E}_{c a p} + Δ {E}_{air} . \qquad ( 1 )$$

Since air is compressible, both ΔE_{cap} and ΔEₐᵢᵣ are affected by V₀. Here we assume that the snapping is an isothermal process and the status of the cap after snapping can be determined via the Boyle's law

$${P}_{c}^{*} {V}_{c} = {P}_{t}^{*} {V}_{t} , \qquad ( 2 )$$

where

$${P}_{c}^{*} = {P}_{0} + {P}_{x}$$

(with x=c or t) is the absolute pressure with P₀=101.3 kPa as the standard atmospheric pressure, Vₓ=V₀+ΔVₓ is the total volume inside the chamber, and the subscripts c and t represent the states before and after the cap snaps, respectively. According to Eq. 2, we can predict the state of the snapped metacap from the initial state of the chamber. For instance, the metacap snaps from state a to state b (FIG. 3D) when V₀=10 mL, and the compressed air release 97.6 mJ energy during the snapping process, which can be calculated by computing the green area shown in FIG. 3D. When V₀=90 mL, the metacap snaps from state a to state c, releasing 370.2 mJ energy from the compressed air, equal to the sum area of green and red regions. Moreover, the energy release from the metacap can be calculated from the elastic energy-volume change curve shown in FIG. 3E, that is 19.3 mJ and −10.3 mJ for V₀=10 mL and 90 mL, respectively. The negative sign indicates that the metacap will absorb energy if V₀ is large enough. Therefore, the total energy release for V₀=10 mL and 90 mL is 116.9 mJ and 359.9 mJ, respectively. As expected, more energy can be released from larger V0, which explains the faster actuation speed observed in FIG. 3B.

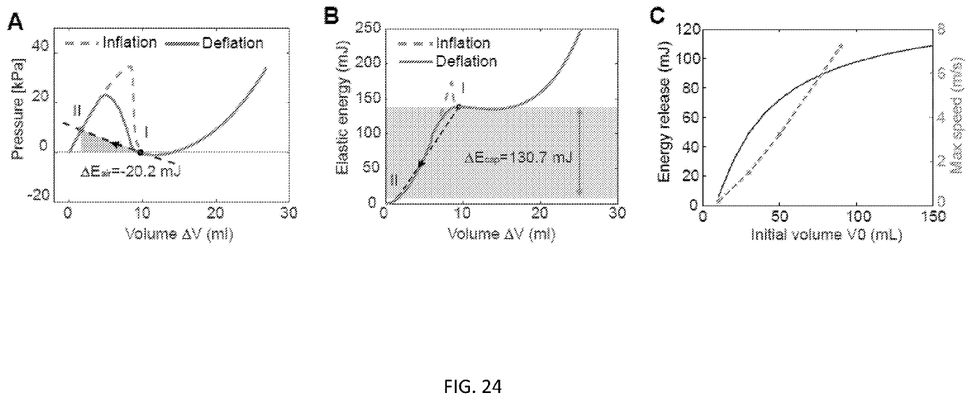

In FIG. 3F, we report the evolution of total energy release as a function of V₀, showing a monotonic relationship. Likewise, the maximum speed of the fingertips of the gripper show a similar trend with V₀ as predicted by our model, that is larger initial volume results in higher snapping speed. To demonstrate this capability of adjusting the actuation speed for diverse objects, we integrate our gripper to a robotic arm (FIG. 3G) and grasp soft objects (i.e. a strawberry) using a gentle actuation (750 ms, V₀=10 mL) to avoid potential damage (FIG. 3H), while using fast actuation speed (8.3 ms, V₀=90 mL) to grasp strong and rigid objects for highly dynamic tasks (FIG. 3I). Note that the closing process of the gripper is slower than the opening with the same V0, because less energy is released during the closing process (FIG. 24).

The soft robotic motion is mostly affected by the rate of deformation and elastic recovery of their compliant body, conventional soft actuators are either comparatively slow when designed with large dimensions (36, 37), or comparatively small to acquire high actuation speed (14, 38). Our passive grippers and pneumatically actuated grippers harness the extraordinary snap-through behavior of metacaps and the compressibility of air, outperforming the conventional soft grippers in terms of the actuation speed and tunability. In FIG. 3I, we compare the actuation speed and dimension between our grippers with a few representative soft actuators based on various actuation approaches reported in the literature. Our grippers exhibit the fastest actuation speed compared with others with dimensions ranging from 1 mm to 20 cm, and benefiting from the tunable actuation speed, our metacap grippers are capable of spanning a large range of time scale (3.75 ms to 750 ms) for actuation, facilitating multipurpose grasping tasks with the same design. Furthermore, the simple geometry and fabrication method make our metacap grippers easy to scale up or down for applications at different length scales.

### Swimming Robots

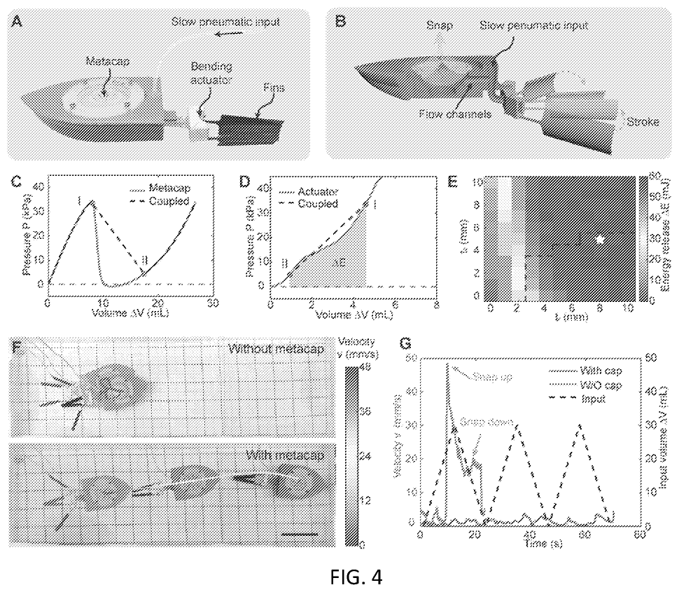

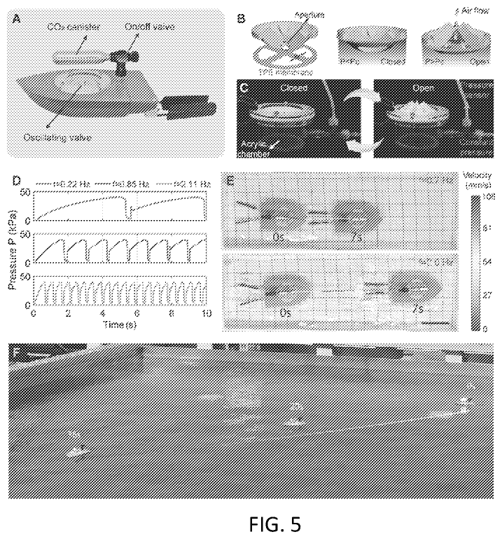

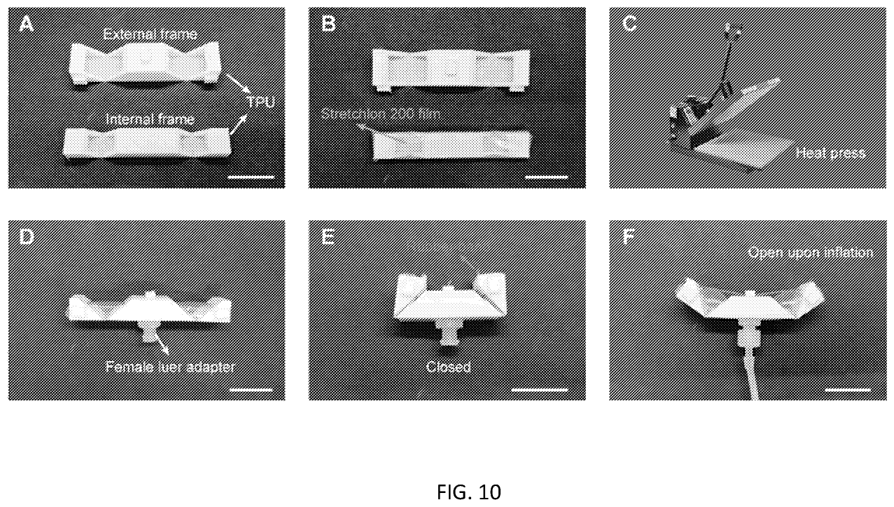

In addition to gripping, the disclosed metacaps can also be utilized to amplify the actuation speed of other actuators, which is useful for applications that require high transient output power. We exemplify this by incorporating the metacap with a bending actuator (see its details in FIGS. 10, 11 and 18) and design a robot capable of swimming rapidly with a relatively slow pneumatic input (FIG. 4A). We connect the metacap and the bending actuator via a 3D printed robotic body (ABS), which is embedded with flow channels for air to exchange, providing buoyancy for the robot to float in water (FIG. 4B). Two fins are mounted at the ends of the bending actuator to generate propulsion for swimming. When supplied with a relatively slow pneumatic input, the bending actuator gradually deforms and opens the fins, while the metacap will not snap until the pressure inside the chamber achieves the critical pressure P_{c}. Once the cap snaps, the pressure inside the chamber decreases immediately, the bending actuator quickly deforms back, driving the fins to generate a large propulsion for swimming. In contrast, if the metacap is replaced by an elastic membrane that cannot snap, the bending actuator deforms monotonically to the input flow rate, and the fins are not able to generate large enough propulsion for swimming. To maximize the propulsive energy from the bending actuator, we use a simple model to quantify the energy release of the bending actuator during the metacap snapping. Specifically, we employ pressure-volume curves of the uncoupled metacap and bending actuator (continuous curves in FIGS. 5C and D) to predict the coupled behavior of the system (dashed lines in FIGS. 5C and D). Upon applying a slow pneumatic input, the metacap and the bending actuator first gradually deform to point I in FIGS. 5C and D. After snapping, the metacap and the bending actuator deform immediately to configurations that correspond to point II under the following constrains

$${P}_{cap} ( Δ {V}_{c a p} ) = {P}_{a c t u a t o r} ( Δ {V}_{a c t u a t o r} ) , \qquad ( 3 )$$

$$Δ Vcap + Δ {V}_{a c t u a t o r} = Δ V , \qquad ( 4 )$$

where P_{cap}(ΔV) and P_{actuator}(ΔV) represent the pressure-volume relationships of the metacap and the bending actuator. ΔV_{cap} and ΔV_{actuator} are the volume change induced by the metacap and actuator upon pressurization, respectively. With this model, we can predict the energy release from the bending actuator by calculating the area of the blue region shown in FIG. 4D. To identify a design of the metacap that makes the robot swim rapidly, we systematically explore the parameter space of the metacap and report the energy release landscape of the bending actuator in FIG. 4E. The effect of tᵣ on the energy release is more pronounced than that of t_{c}, and when tᵣ is large enough (tᵣ≥6 mm) the energy release stabilizes to a constant. However, the parameters above the dashed lines may not be desired in all situations, because these parameters correspond to monostable metacaps and the bending actuator cannot fully close after the monostable metacap snaps due to the residual pressure inside the chamber, and the unclosed fins gives rise to large resistance during swimming.

For proof-of-principle, we test two robots with and without the metacap in a water tank (30 cm in width and 90 cm in length, see FIG. 4F). The metacap has tᵣ=8 mm and t_{c}=5 mm (highlighted in FIG. 4E). By supplying with the same input (see the input profile in FIG. 4G), the swimming robot with a non-snapping membrane moves around at the same position and barely swims forward, while the one with metacap can swim forward with a much faster speed after the cap snaps. In FIG. 4G, we compare the instantaneous velocity of these two robots and it is clear that the robot with metacap has much faster speed characterized by two peaks resulted from the snapping up and snapping down of the metacap.

### Oscillating Valve Enabled Untethered, Electronics-Free Robots

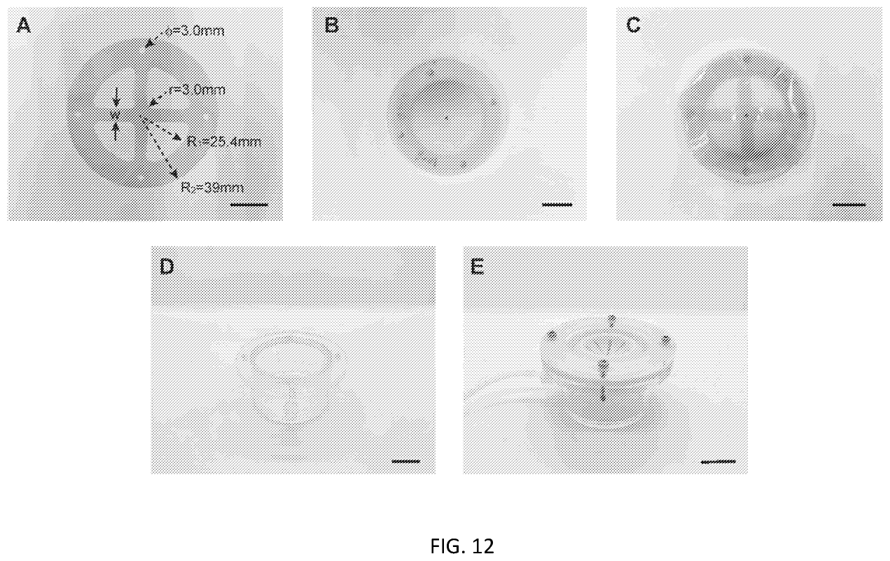

Although our metacap can accelerate the speed of the swimming robot significantly, the robot is controlled by a tethered electronic pump. To make the robot electronics-free and untethered, we introduce an oscillating valve actuated by a CO₂ canister (FIG. 5A). The valve includes a monostable metacap with an aperture (3 mm in diameter) at the center of the cap, which is covered by a thermoplastic elastomer (TPE) membrane (FIG. 5B and FIG. 12). When the pressure inside the chamber P is smaller than Pc, the aperture remains sealed by the membrane. However, when P is larger than P_{c}, the cap snaps, opening the valve. Thus, air inside the chamber flows out through the aperture, leading to a dramatic pressure decrease inside the chamber. Since the metacap is monostable, it will snap back when P is lower than a certain valve (˜3.5 kPa) and the aperture will be sealed by the membrane again. Hence, the valve exhibits an oscillating response when it is supplied with a constant pneumatic input.

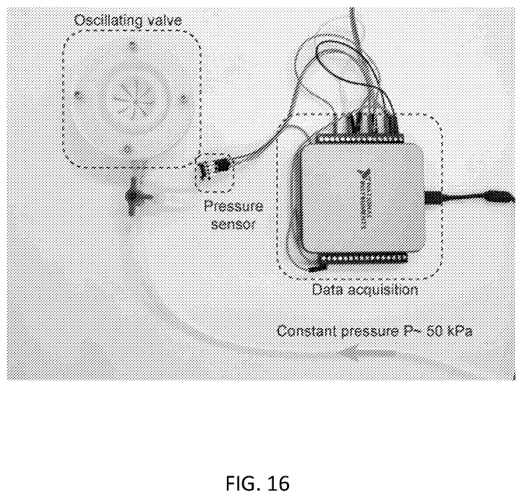

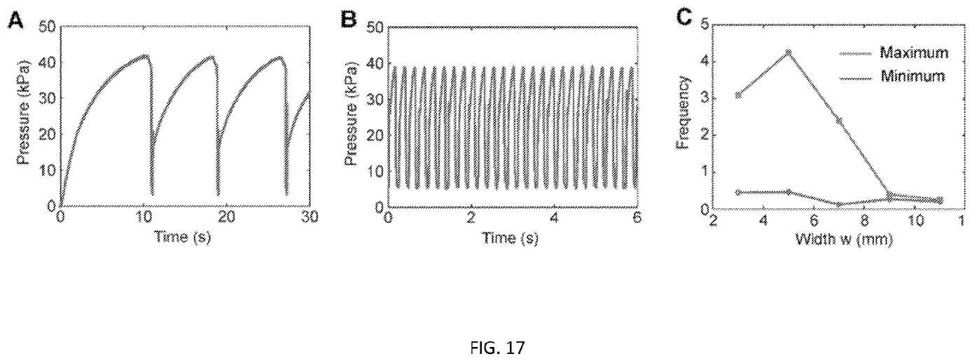

To characterize the oscillating response of the valve, we mount the metacap (t_{c}=10 mm, tᵣ=10 mm, φ_{c}=12°) and the TPE membrane to an acrylic chamber with volume of 100 mL (FIG. 5C) and monitor the evolution of the pressure inside the chamber using a pressure sensor (ELVH-015D, All Sensors, FIG. 16). By supplying the chamber with a constant pressure input, the metacap snaps up and down periodically, resulting in an oscillatory pressure profile inside the chamber. Moreover, we find that the oscillatory frequency of the valve can be readily tuned by varying the flow rate of the input. In FIG. 5D, we show three pressure profiles of the same valve when supplied with a constant pressure (˜50 kPa) at low (˜3 mL/s, red curve), medium (˜13 mL/s, blue curve) and high (˜32 mL/s, green curve) rates, and the oscillatory frequency of the valve varies from 0.22 to 2.11 Hz. The maximum and minimum oscillating frequencies for each valve is determined by the geometry of the metacap and the membrane, as well as the cavity of the chamber. In this study, we fix the geometry of the metacap and the chamber, but vary the width (w) of the membrane (FIG. 5B), leading to a wide range of oscillating frequency f∈[0.12, 4.25] when w∈[3, 11] mm (FIG. 17). Although oscillating valves have been reported (45-47), ours outperform the existing systems in three aspects: (i) it does not require a complex circuit to control oscillation; (ii) there isa sharp pressure drop, which is beneficial for rapidly responsive robots; (iii) a wide range of oscillating frequencies can be achieved by simply tuning the input flow rate.

With the oscillating valve, we can not only make the swimming robot untethered and electronics-free, but also tune the swimming speed by varying the input flow rate from the CO₂ canister, achieving stroke frequency ranging from 0.7 Hz to 2.0 Hz, capable of swimming 29 cm and 50 cm in 7 s, respectively (FIG. 5E). The lines in FIG. 5E indicate the trajectories of the robots and the colors of the lines represent the instantaneous velocity of the robot. Our swimming robot is highly efficient as it can work for more than 1 min at 1 Hz when supplied with a 12 g CO2 canister, and it can across the diagonal of a swimming pool (6 m*6 m) in 40 s (FIG. 5F).

### DISCUSSION

Inspired by recent advances in metamaterials, we have developed a class of metacaps with an array of ribs to a simple spherical cap. Through finite element simulations, numerical modelings and experimental demonstrations, we investigated the mechanical response of metacaps with various geometries, the interaction between metacaps and compressible air, and the coupling between metacaps and conventional bending actuators. The rich nonlinear mechanical responses of the metacaps and the remarkable interactions between metacaps, air and conventional actuators facilitate several robotic systems with unprecedented functionalities to address the current limitations of soft robots, including limited actuation speed, absence of sensing capability and dependence of complex control system.

The passive grippers are capable of grasping diverse objects automatically upon application of a certain contact force. A fastest actuation speed (3.75 ms for grasping) is achieved in comparison to other soft grippers reported in the literature. We show that the passive grippers have great potentials in sports equipment and industrial applications due to their remarkable adaptability and maneuverability, simple geometry, low cost and ease of fabrication. The pneumatically controlled grippers uncouple the actuation speed from the input and realize tunable actuation speed by adjusting the initial cavity of the chamber.

Last, we show that our metacaps can be used to pneumatically regulate swimming robots for high transient energy output, exhibiting remarkably higher efficiency than those without the metacap. In turn, our study provides insights for swimming and underwater robots for oceanic exploration. By varying the input flow rate, the oscillating valves exhibit a wide range of oscillating frequencies, provide new solutions to design untethered and electronics-free pneumatic robots, and are beneficial for applications that are sensitive to spark ignition.

The metacap has allowed us to infiltrate into the property space that was previously inaccessible from conventional metamaterials and uncover novel soft robots with unprecedented performance which is not achievable with simple spherical caps of uniform thickness. Despite diverse applications demonstrated in this paper, our metacaps hold the potential for numerous applications that requiring high transient output energy in biomedical engineering and robotic systems ranging from ventricular assist devices (48, 49) and soft mechanotherapy devices (45) to locomotive and jumping robots (50, 51). We envision that our metacaps would enrich the spectrum of designing soft robots with novel functions towards ultra-fast speed, programmable response, autonomous and electronics-free.

### Materials and Methods

### Fabrication of Metacaps

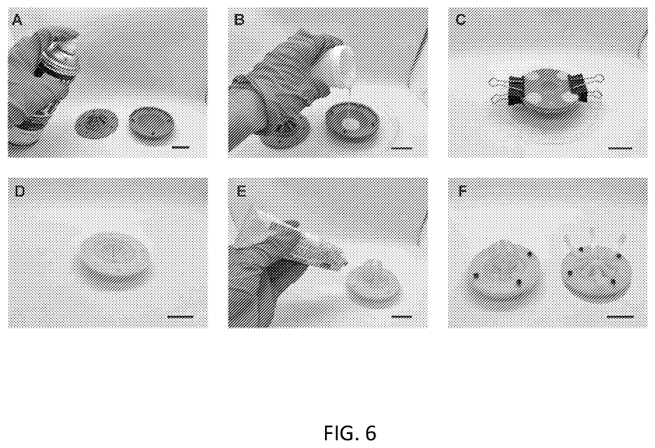

The metacaps investigated in this study were made of vinyl-polysiloxane VPS (Elite Double 32, Zhermack) and flexible urethane rubber (Flex 80, Alumilite) for applications requiring different mechanical responses. The metacaps were casted using the two-part molds shown in FIG. 6A, which were 3D printed in TR300 ultra-high temperature resin with a digital light processing printer (Sonic Mini 4k, Phrozen).

### Fabrication of Passive Grippers

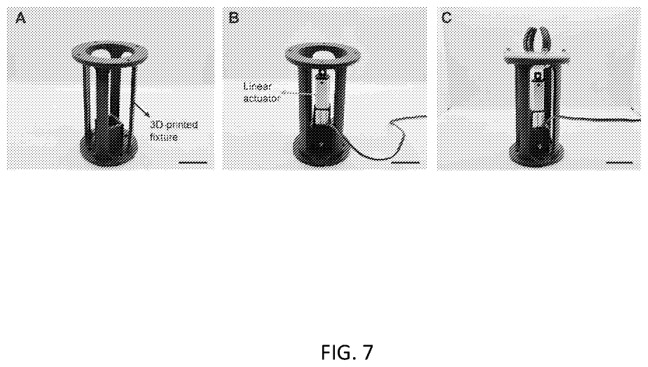

4 curved fingers were 3D printed using acrylonitrile butadiene styrene (ABS) material with a Ultimaker 8 printer. We glued the fingers to the ribs of the metacap using Sil-Poxy (Silicone Adhesive, Smooth-On) for Elite Double 32 metacaps and using super glue (Starbond) for Flex 80 metacaps (FIG. 6E). Then, we clamped the border of the metacap using two acrylic plates and fixed the acrylic plates with four bolts (FIG. 6F). To fabricate a passive gripper for the robotic system (Franka Emika Panda), we first 3D printed a frame shown in FIG. 7A and mounted a linear actuator (USLICCX LA-T8) at the center of the frame. Then we assembled a metacap gripper to the frame and integrated the frame to the robotic system.

### Fabrication of the Baseball Glove

Punched a large hole (with diameter φ˜30 mm) and four small holes (with diameter φ˜3 mm) at the center of the baseball glove. The small holes are evenly distributed on a reference circle of 64 mm in diameter. Fabricated a gripper with the metacap made of Flex 80. Incorporated the metacap gripper to the baseball glove using acrylic plates and bolts. The gripper can be opened by pushing the metacap through the large hole in the glove and a baseball can be tightly grasped when it hits on the center of the metacap gripper.

### Fabrication of Pneumatically Actuated Grippers

3D printed a piston, a male and a female threaded shafts using ABS materials. The piston was coated with a thin layer of instant adhesive (LOCTITE 406) to avoid leakage. Assembled the piston and the shafts into an acrylic tube. An O-ring was placed between the piston and the tube to avoid leakage. The female shaft was glued to the acrylic tube and the piston was connected to the male shaft via a steel rod. Fixed the metacap gripper to the flange of the acrylic tube using four bolts.

### Fabrication of Swimming Robots

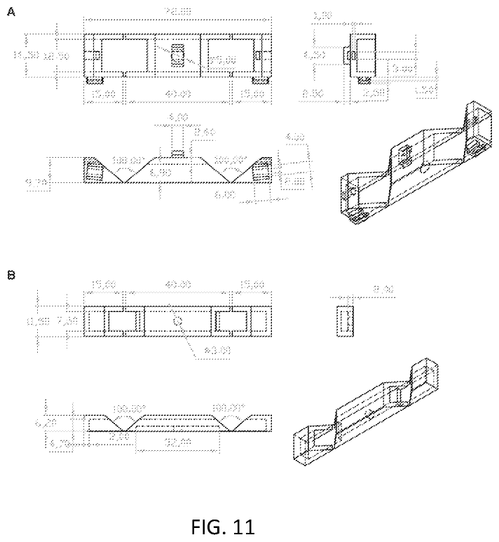

The bending actuator of the swimming robot includes of two TPU frames with the internal one encapsulated by a thermoplastic elastomer (TPE) membrane with thickness of 0.0015 inch (Sketchlon 200, Airtech International). To fabricate the bending actuator, we use the following steps (i) 3D printed the internal and external frames using the TPU material with a Ultimaker 8 printer. The geometries of the frames can be found in FIG. 11. (ii) encapsulated the internal frame using the Stretchlon 200 membrane and transfered the encapsulated internal frame to a heat press (Fancier Studio) to seal the membrane at 140° C. The sealed membrane forms an airtight pouch for the internal frame. (iii) Embedded the encapsulated internal frame into the external one and incorporated a female Luer adapter to the frames for fluidic connection. (iv) inserted a prestretched rubber band (with initial length, width and thickness being 15 mm, 3 mm and 1 mm, respectively, the pre-strain of the rubber band is around 2.2) to the external frame, which bends the actuator to the closed state shown in FIG. 10E. The body of the swimming robot was printed using ABS material with a Ultimaker 8 printer, which was coated with an instant adhesive (LOCTITE 406) to avoid leakage. Assembled the bending actuator, metacap and 3D printed fins to the to the body of the swimming robot.

Characterization of materials and metacaps The mechanical property of Elite Double 32 and Flex 80 was characterized by uniaxial tensile tests. All mechanical testing was performed using a universal testing machine (5564, Instron, Inc., USA) equipped with a 100N load cell under displacement control at a strain rate of 0.01 per second. The mechanical response of the metacap was tested in a water tank to eliminate the influence of gravity and the compressibility of air. We connected the metacap to an acrylic chamber and filled the chamber with the amount of water corresponding to the initial volume of the cavity. We submerged the structure in a water tank, and use a syringe pump (mounted on a linear translation stage, LT800, Thorlabs) to displace an additional volume of water ΔV into the chamber at a rate of 15 mL/min and recorded the pressure using a pressure sensor (ELVH-015D, All Sensors).

Characterization of grippers and oscillating valves The actuation speed of passive grippers and pneumatically actuated grippers are recorded using a high-speed camera (FASTCAM SA1.1, Photron) at frame rates between 1000 to 8000 fps for measurements of different speeds. We placed two markers at the tips of the gripper fingers and tracked their position and speed during the actuation using an open-source digital image correlation and tracking package (52). To characterize the mechanical response of oscillating valves, we connected the oscillating valve to an acrylic chamber with volume around 100 mL and supplied it with pressurized air of a constant flow rate. The pressure of the air was regulated by a general purpose regulator (10-572-1E, Fisherbrand) to˜50 kPa and the pressure evolution inside the chamber was measured using a pressure sensor (ELVH-015D, All Sensors).

Finite element simulations The finite element analyses were performed in the commercial package ABAQUS 2020/Standard. The mechanical response of the caps was captured using an incompressible Gent model with strain energy function W given by

$$W = - \frac{μ {J}_{m}}{2} ln ( 1 - \frac{{I}_{1} - 3}{{J}_{m}} ) ,$$

where μ represents the small strain shear modulus, Jₘ is a material parameter related to the limiting value of stretch, I1=trF^{T}F is the first invariant of the right Cauchy-Green deformation tensor and F is the deformation gradient. Guided by our experiments, the mechanical response of Elite Double 32 and Flex 80 is accurately captured using (μ, Jₘ)=(0.36 MPa, 11.2) and (1.55 MPa, 5.0), respectively. An in-house ABAQUS user subroutine (UHYPER) was used to define the hyperelastic material behavior given in the FE simulations. We conducted full 3D FE simulations for the metacaps and discretized the caps using a non-structured mesh of 4-node linear tetrahedron elements (ABAQUS element type: C3D4H) with mesh size of 0.6 mm to ensure that at least four elements are used to discretize the thickness of metacaps. All 3D models were inflated via a fluid cavity interaction with a hydraulic fluid (of density ρ=1000 kg/m³ and bulk modulus B=2.2 GPa). The volume-controlled inflation was driven by a fictitious thermal expansion of the hydraulic fluid, relating to the change in volume ΔV in the cavity through

$$\frac{Δ V}{{V}_{0}} = 3 α T Δ T ,$$

where ΔT is the change in temperature, αT is the coefficient of thermal expansion of the fluid and V0 is the initial volume of the cavity. In the simulations, we set αT=1 [1/K] and gradually increase the temperature ΔT until 0.5. The deformation of the metacaps was simulated by conducting non-linear dynamic implicit simulations (*Dynamic Implicit module in ABAQUS with NLGEOM on) and the kinetic energy of the model was monitored to ensure quasi-static conditions.

### ADDITIONAL DISCLOSURE

### Fabrication

Metacap gripper. The metacaps investigated in this study are made of vinyl-polysiloxane (VPS, Elite Double 32, Zhermack) and flexible urethane rubber (Flex 80, Alumilite) for tuning mechanical responses. The metacaps are cast into the two-part molds shown in FIG. 6A, which are 3d printed in TR300 ultra-high temperature resin with a Sonic Mini 4k printer (Phrozen). The metacap grippers are fabricated in 6 steps (see FIG. 6):
Step A: coat internal mold surfaces with a release agent (Ease Release 200 spray, Mann Release Technologies) to facilitate the removal of the cured metacaps.
Step B: pour a mixture of equal amounts of Elite Double 32 base and catalyst into the bottom part of the molds.
Step C: slowly place the top part of the molds on top of the bottom one, allowing for the excess materials to flow out of the mold. Clamp the molds with binder clips and wait 20 min to cure and achieve uniform thickness.
Step D: remove the metacap from the molds.
Step E: 3D print 4 curved fingers using acrylonitrile butadiene styrene (ABS) material with a Ultimaker 8 printer. Glue the fingers to the ribs of the metacap using Sil-Poxy (Silicone Adhesive, Smooth-On). Note that we use super glue (Starbond) to glue the fingers on metacaps made of Flex 80.
Step F: Clamp the border of the metacap using two acrylic plates and fix the acrylic plates with four bolts.

Passive gripper for integration in a robotic arm. To fabricate a passive gripper that can be integrated into the robotic arm (Franka Emika Research 3), we adopt the following steps (FIG. 7):
Step A: 3D print a frame shown in FIG. 7A to fix the metacap.
Step B: mount a linear actuator (USLICCX LA-T8) at the center of the frame.
Step C: glue 3D printed fingers on the metacap and fix them to the top flange of the frame using bolts. Mount the assembly to the robotic system (Franka Emika Research 3).

Baseball glove integrated with a metacap gripper. (FIG. 8):
Step A: punch a large hole (with diameter φ˜30 mm) and four small holes (with diameter φ˜3 mm) at the center of the baseball glove. The small holes are evenly distributed on a reference circle of 64 mm in diameter.
Step B: fabricate a gripper with the metacap made of Flex 80.
Step C: fix the metacap gripper to the baseball glove using acrylic plates and bolts.
Step D: push the metacap through the large hole in the glove to open the gripper.
Step E: the glove is ready to capture objects.
Step F: a baseball can be tightly grasped when it hits on the center of the metacap gripper.

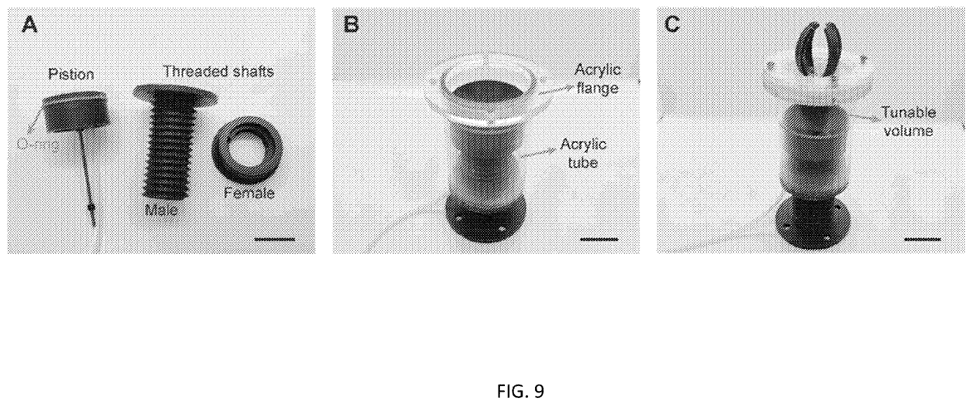

Pneumatic gripper. To make the gripper with tunable actuation speed, we integrate it to a chamber with adjustable cavity. The pneumatically actuated gripper can be fabricated using the following steps (FIG. 9):
Step A: 3D print a piston, a male and a female threaded shafts from ABS. The piston is coated with a thin layer of instant adhesive (LOCTITE 406) to avoid leakage.
Step B: assemble the piston and the shafts into an acrylic tube. An O-ring is placed between the piston and the tube to avoid leakage. The female shaft is glued to the acrylic tube and the piston is fixed to the male shaft via a steel rod.
Step C: fix the metacap gripper to the flange of the acrylic tube.

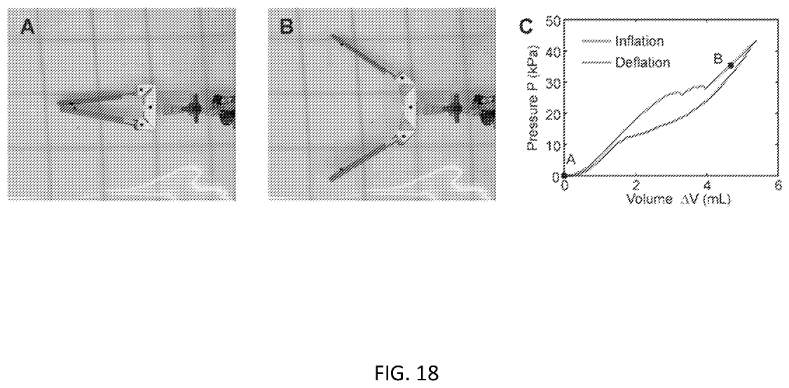

Bending actuator. The bending actuator of the swimming robot is used to control the movement of the fins, which generates propulsion to drive the swimming. The actuator includes two TPU frames with the internal one encapsulated by a thermoplastic elastomer (TPE) membrane (Sketchlon 200, Airtech International) with thickness of 0.0015 inch. It is fabricated according to the following steps (FIG. 10):
Step A: 3D print the internal and external frames from TPU (NFC TPU-95A, Ultimaker) using the Ultimaker 8 printer. The geometries of the frames can be found in FIG. 11
Step B: encapsulate the internal frame using the Stretchlon 200 membrane.
Step C: transfer the encapsulated internal frame to a heat press (Fancier Studio) and seal the membrane at 140° C. The sealed membrane forms an airtight pouch for the internal frame.
Step D: embed the encapsulated internal frame into the external one and insert a female Luer adapter to the frames for fluidic connection.
Step E: insert a pre-stretched rubber band (an initial length, width and thickness of 15 mm, 3 mm and 1 mm, respectively, the pre-stretch ratio is 2.2) to the external frame, which will bend the actuator to the closed state shown in FIG. 10E.
Step F: the bending actuator opens upon inflation. See the mechanical characterization of the bending actuator in FIG. 18.

Oscillating valve. To realize an untethered and electronics-free swimming robot, we design an oscillating valve and fabricate it using the following steps (FIG. 12):
Step A: cut the Stretchlon 200 membrane to the geometry shown in FIG. 12A using Cricut Explore Air 2.
Step B: cast a monostable metacap with a hole (3 mm in diameter) at the center of the cap.
Step C: place the membrane on top of the metacap to cover the hole with the membrane.
Step D: make an acrylic chamber shown in FIG. 12D.
Step E: fix the metacap and the membrane to the acrylic tube using an acrylic plate and four bolts.

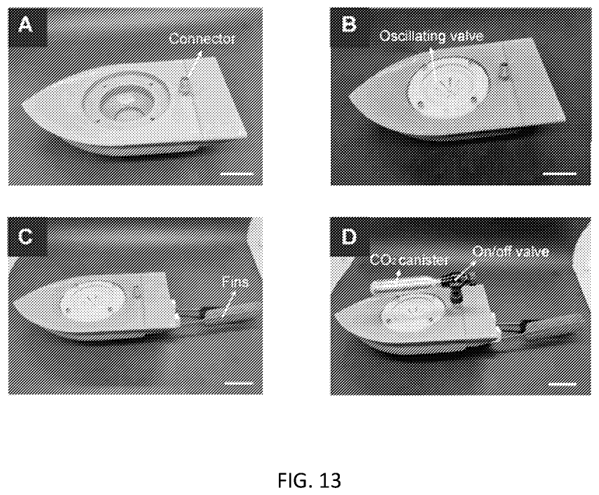

Electronics free swimming robot. We use the following steps to fabricate the swimming robot (FIG. 13):
Step A: 3D-print the robot body using ABS by the Ultimaker 8 printer. Coat the internal surface of the body using instant adhesive (LOCTITE 406) to avoid leakage. Glue a connector to the body for input.
Step B: mount the oscillating valve to the chamber of the swimming robot.
Step C: assemble the bending actuator with two 3D printed fins and mount them to the robot.
Step D: connect a CO₂ canister and an on/off valve to the swimming robot as the input resource.

### Experiments

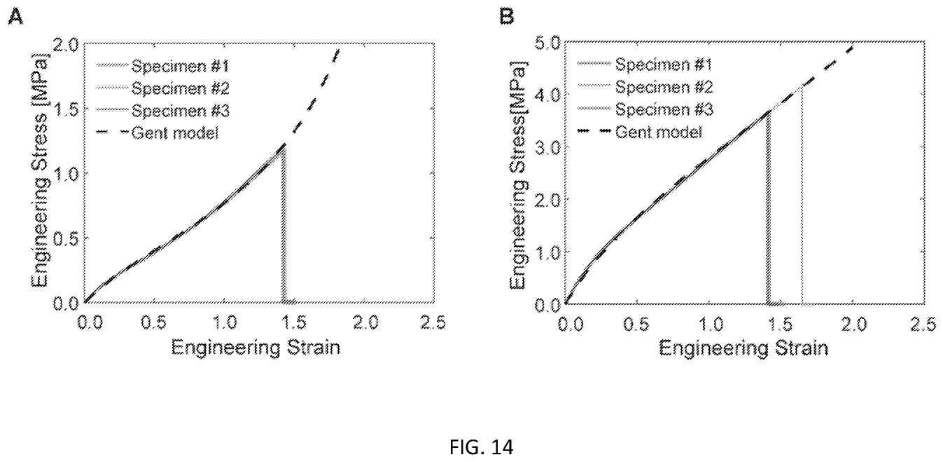

Material characterization. Two materials (i.e. Elite Double 32 and Flex 80 elastomers) are used to fabricate the metacaps. To characterize their mechanical responses, we conduct uniaxial tensile tests (5564, Instron, Inc., USA) equipped with a 100N load cell under displacement control at a strain rate of 0.01 per second. The engineering stress-strain curves are reported in FIG. 14.

We model the mechanical responses of Elite Double 32 and Flex 80 elastomers using an incompressible Gent material model with a strain energy density function W given by

$$W = - \frac{μ {J}_{m}}{2} ln ( 1 - \frac{{I}_{1} - 3}{{J}_{m}} ) , \qquad [ 6 ]$$

where μ represents the small strain shear modulus, Jₘ is a material parameter related to the limiting value of stretch and I₁=trF^{T}F with F being the deformation gradient. The mechanical responses of Elite Double 32 and Flex 80 are accurately captured using (μ, Jₘ)=(0.36 MPa, 11.2) and (1.55 MPa, 5.0), respectively. See comparisons between the experimental results and theoretical predictions of the uniaxial tensile stress-strain curves in FIG. 14.

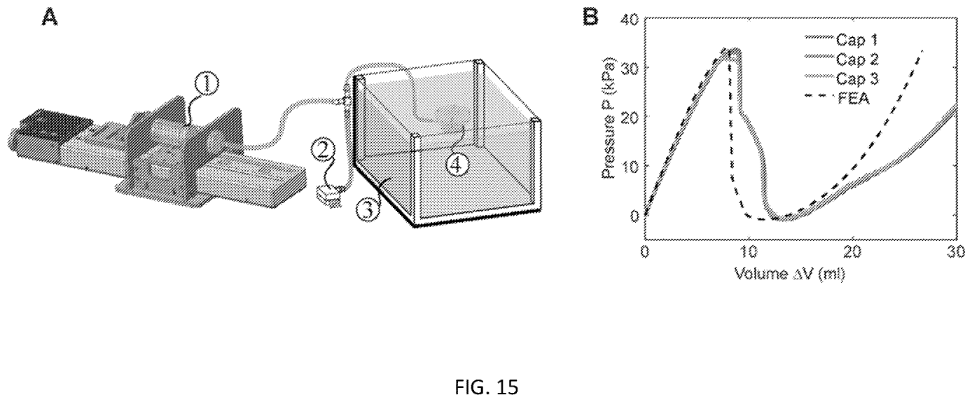

Characterization of the mechanical responses of the metacaps. The metacap is first connected to an acrylic chamber and inflate the chamber using water. We then submerge the structure in a water tank to eliminate the influence of gravity and compressibility of air and fill the chamber with water corresponding to the initial volume of the cavity. A syringe pump (mounted on a linear translation stage, LT800, Thorlabs) is used to displace an additional volume of water ΔV into the chamber at 15 mL/min and record the pressure using a pressure sensor (ELVH-015D, All Sensors). See schematic of the experimental setup in FIG. 15.

Characterization of the oscillating valve. The mechanical response of the oscillating valve is affected by the geometry of the metacap, the geometry of the TPE membrane, and the input flow rate. In our study, we test the metacap with R=30 mm, φ=57.85°, t/R=0.075, φₒ=5.0°, φ_{c}=12.0°, θᵣ=47.85°, θᵣ=35.0° and t_{c}=tᵣ=10 mm and tune the response of the oscillating valve by varying the width (w) of the membrane (FIG. 12A) and the input flow rate. We connect the oscillating valve to an acrylic chamber with volume of 100 mL and measure the pressure evolution inside the chamber using a pressure sensor (ELVH-015D, All Sensors). The pressure inside the chamber oscillates when the valve is supplied with pressurized air of a constant flow rate. The frequency of the oscillating valve is determined by the time that the input flow used to increase the pressure inside the chamber and the time that the net flow (between the input flow and output flow coming out from the hole of the metacap) used to decrease the pressure inside the chamber. Therefore, the input flow cannot be larger than the output flow in order to make the valve functional, and there are a lowest and a highest oscillating limits for a specific valve.

Without being bound to any particular theory or embodiment, the lowest limit exists because the metacap deforms asymmetrically a bit before it snaps, possibly due to non-even thickness, leading to a slight leakage of the valve. If the input flow rate is less than the leaking rate of the valve, the metacap is not able to snap. Therefore, there is a lowest flow rate to activate the valve, which also restricts the lowest frequency accordingly. Moreover, the oscillating frequency is not monotonically increased as the input flow becomes larger, since longer time for the metacap to snap back is also needed. Hence, the valve has a limit of the highest oscillating frequency.

To characterize the capability of the oscillating valve, we vary the geometry of the membrane and record the oscillating frequency of the valve at different input flow rates. The minimum oscillating frequency fₘᵢₙ˜0.12 is achieved with w=7 mm (FIG. 17A), and the maximum oscillating frequency fₘₐₓ˜4.25 is achieved when w=5 mm (FIG. 17B). In FIG. 17C, we report the evolution of the maximum and minimum frequencies of the valve as a function of the TPE membrane. From the figure we find that the maximum frequency increases first and then as the width w increases the maximum frequency decreases significantly. This is because the valve with membrane of larger width has smaller output flow rate. In contrast, the width w has less effect on the minimum frequency when compared with that on the maximum frequency.

Testing of the bending actuators. The bending actuators are tested in a water tank to eliminate the influence of gravity and compressibility of air. In FIGS. 18A and B, we report the snapshots of the bending actuator with fins at the closed and open states, respectively. The pressure-volume curves for the inflation and deflation can be found in FIG. 18C.

### Numerical Simulations

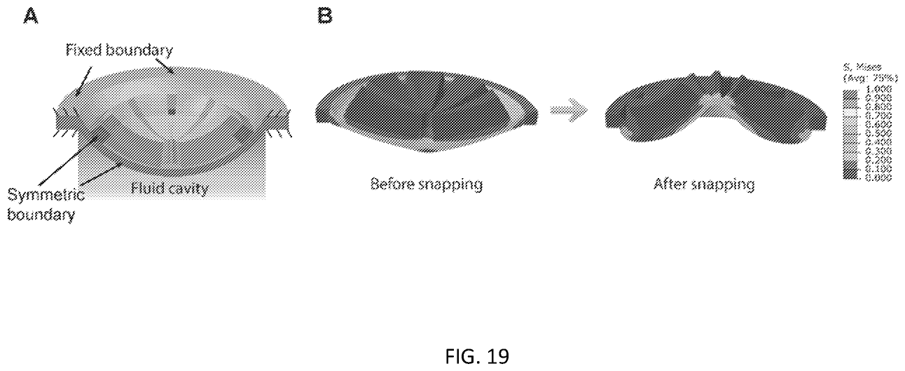

To demonstrate how the metacaps outperform the simple caps in terms of the snap-through behaviors, we conduct finite element (FE) analyses to investigate the response of the caps with variable geometries upon pressurization using the commercial package ABAQUS 2020/Standard. The mechanical response of the caps is captured using an incompressible Gent model Eq. 6. Guided by experiments, the mechanical response of Elite Double 32 and Flex 80 is accurately captured using (μ, Jₘ)=(0.36 MPa, 11.2) and (1.55 MPa, 5.0), respectively. An in-house ABAQUS user subroutine (UHYPER) is used to define the hyperelastic material behaviors given in the FE simulations. We conducted full 3D FE simulations for the metacaps and discretized the caps using a non-structured mesh of 4-node linear tetrahedron elements (ABAQUS element type: C3D4H) with mesh size of 0.6 mm to ensure that at least four elements are used to discretize the thickness of metacaps. The border of the metacap is fixed to mimic the clamped boundary condition. Because of the symmetric geometry and deformation, we simulate half cap and apply symmetric boundary conditions to corresponding surfaces (FIG. 19A). All 3D models are inflated via a fluid cavity interaction with a hydraulic fluid (of density ρ=1000 kg/m³ and bulk modulus B=2.2 GPa). The volume-controlled inflation is driven by a fictitious thermal expansion of the hydraulic fluid, relating to the change in volume ΔV in the cavity through

$$\frac{Δ V}{{V}_{0}} = 3 α T Δ T , \qquad [ 7 ]$$

where ΔT is the change in temperature, αT is the coefficient of thermal expansion of the fluid and V₀ is the initial volume of the cavity. In the simulations, we set αT=1 [1/K] and gradually increase the temperature ΔT until 0.5. The deformation of the metacaps was simulated by conducting non-linear dynamic implicit simulations (*Dynamic Implicit module in ABAQUS with NLGEOM on) and ensure quasi-static conditions by monitoring the kinetic energy of the model.

### FIGURES

FIG. 1. Design and characterization of the metacaps. (A) A spherical cap with low thickness-to-radius ratio exhibits an asymmetric snapping instability when inflated. (B) A thick cap of the same radius is more robust showing a symmetric deformation mode but lacking in snapping. (C) A metacap with architected structures, whose mechanical behaviors can be regulated by the geometries of the ribs. (D) The pressure-volume curves, normalized by initial shear modulus, μ, and radius, R, of the thin cap (t₁/R=0.075, grey line), thick cap (t₂/R=0.15, green line) and metacap (t/R=0.075, φₒ=5.0°, φ_{c}=8.0°, t_{c}/R=0.133, φᵣ=47.85°, θᵣ=35.0°, tᵣ/R=0.267, red line). (E) Evolution of the elastic energy as a function of the volume change for different caps. The inset shows the hysteresis of the thin cap upon inflation and deflation. (F) Landscape of the energy release Eᵣ upon deflation as a function of tᵣ and t_{c}. (G) Landscape of the energy barrier E_{b} upon deflation as a function of tᵣ and t_{c}.

FIG. 2. Passive metacap grippers. (A) Schematics of the passive gripper that closes upon applying a certain force at the center of the cap. The cap is fixed by two acrylic plates through four bolts, and four 3D printed fingers (ABS) are glued on the ribs of the cap to catch the objects. (B) The grippers can grasp objects of different shapes, moduli and weights. (C) The gripper is capable of realizing highly dynamic grasping tasks. A ball hits at the center of the cap with a speed around 5.8 m/s is caught by the gripper in 3.75 ms. (D) Integration of the gripper to a baseball glove facilitates the grasping of the baseball. (E,F) The metacap gripper is integrated into a robotic arm (Franka Emika Panda) and controlled by a linear actuator (USLICCX LA-T8) for open, and the close is fully passive.

FIG. 3. Pneumatically actuated grippers with tunable speed. (A) An experimental snapshot of the actuator. The metacap gripper is clamped to an acrylic chamber whose volume is tunable by changing the position of the 3D printed piston. (B) Experimental snapshots of the opening process of grippers with different initial volumes. The one with V₀=10 mL takes 500 ms to deform from the closed state to the open state, while the one with V₀=90 mL needs 6.75 ms to snap open, indicating that actuation speeds can be tuned by the initial volume of the chamber. (C) Schematic of the pneumatically actuated gripper before and after snapping. P_{c} and V_{c} are the critical pressure and volume inside the chamber before the metacap snaps. Pₜ and Vₜ represents the current pressure and volume after the metacap snaps. (D) The energy release from compressed air during the snapping process can be calculated from the pressure-volume curve of the metacap via the Boyle's law. (E) Evolution of the strain energy of the metacap as a function of volume change. When the initial volume V₀=10 mL, the metacap releases 19.3 mJ energy during the snapping, while absorbing 10.3 mJ energy when V₀=90 mL. (F) Evolution of the total energy release and the maximum speed of the gripper as a function of the initial volume V₀. (G) Experimental snapshots of the metacap gripper with V₀=10 mL, taking 750 ms to grasp a strawberry gently. (H) Experimental snapshots of the metacap gripper with V₀=90 mL, taking 8.3 ms to grab a plastic ball. (I) Comparison of the actuation speed and dimension from our metacap grippers vs. those from the soft actuators reported in literature based on pneumatic actuation (21, 35-38), swelling (14), application of electric field (39-41) and magnetic field (42), and thermal activation (43, 44). Our grippers exhibit the fastest actuation speed while also being tunable for multipurpose applications.

FIG. 4. The metacap enabled swimming robot with amplified swimming speed. (A) An experimental snapshot of the swimming robot comprising a 3D printed body, a metacap and a bending actuator that controls the movement of the fins. (B) Schematic of the mechanism of the swimming robot. (C) Pressure-volume curves of the metacap with and without coupling. (D) Pressure-volume curves of the bending actuator with and without coupling. (E) The landscape of energy release from the bending actuator for a stroke as a function of the thickness of t_{c} and tᵣ. (F) Experimental snapshots of the swimming robots with and without the metacap, both of them are supplied with the same pneumatic input. Scale bar, 10 cm. (G) Comparison of the instantaneous velocity between these two robots together with the profile of the input volume.

FIG. 5. Oscillating valves enable untethered and electronics-free swimming robots. (A) An experimental snapshot of the untethered and electronics-free swimming robot. (B) Design and working mechanism of the oscillating valve. The valve comprises a monostable metacap with an aperture at the center of the cap and a TPU membrane. (C) Experimental setup for characterizing the oscillating valve. (D) Various pressure profiles obtained from varying the input flow rate of the valve. (E) Experimental comparison of the swimming speed for robots with different stroke frequencies. Scale bar, 10 cm. (F) Experimental snapshots of the robot tested in a swimming pool. The robots can across the diagonal of the swimming pool (˜6 m*6 m) in 40 s.

FIG. 6. Fabrication of the metacap grippers. Snapshots of 6 steps used to fabricate the passive gripper. Scale bars, 30 mm.

FIG. 7. Fabrication of the passive grippers. Snapshots of the 3 steps used to fabricate the passive gripper. Scale bars, 30 mm.

FIG. 8. Fabrication and operation of the baseball glove with Integrated metacap gripper. Snapshots of the 6 steps used to fabricate and operate the baseball glove. Scale bars, 30 mm.

FIG. 9. Fabrication of the pneumatic grippers. Snapshots of the 3 steps used to fabricate the pneumatic gripper. Scale bars, 30 mm.

FIG. 10. Fabrication of the bending actuators. Snapshots of the 6 steps used to fabricate the bending actuators. Scale bars, 20 mm.

FIG. 11. Geometry of the bending actuator. (A) Geometry of the external frame. (B) Geometry of the internal frame. Unit: mm.

FIG. 12. Fabrication of the oscillating valve. Snapshots of the 5 steps used to fabricate the oscillating valve. Scale bars, 30 mm.

FIG. 13. Fabrication of the untethered and electronics-tree swimming robot. Snapshots of the 4 steps used to fabricate the swimming robot. Scale bars, 30 mm.

FIG. 14. Comparisons of the uniaxial tensile stress-strain curves between the experimental results (solid lines) and theoretical predictions from the Gent model (dashed line). (A) The mechanical response of Elite Double 32 is accurately captured using μ=0.36 MPa and Jₘ=11.2. (B) The mechanical response of Flex 80 is accurately predicted using μ=1.55 MPa and Jₘ=5.0.

FIG. 15. Experimental validation on the mechanical behavior of the metacap. (A) Schematic of the experimental setup to characterize the pressure-volume relations of metacaps. (1) Syringe pump based on a linear translation stage (LT800, Thorlabs). (2) Pressure sensor (ELVH-0150, All Sensors). (3) Water tank. (4) Metacap mounted on a chamber. (B) Comparison between experimental (continuous lines) and numerical (dashed line) results on the pressure evolution inside the chamber of the metacap.

FIG. 16. Experimental setup for characterization of the oscillating valve. We supply the valve with a constant pressure input (˜50 kPa) and measure the pressure profile in the chamber using a pressure sensor (ELVH-015D, All Sensors).

FIG. 17. Effect of the geometry of the TPE membrane on the mechanical response of the oscillating valve. (A) The pressure profile corresponding to the lowest oscillating frequency of the valve with w=7 mm. (B) The pressure profile corresponding to the highest oscillating frequency of the valve with w=5 mm. (C) The upper and lower limits of the oscillating frequency with varied width of the membrane.

FIG. 18. Experimental characterization of the bending actuator. (A, B) Experimental snapshots of the bending actuator at the (A) closed and (B) open states. (C) Evolution of the pressure as a function of the volume change for the bending actuator upon inflation and deflation, showing a hysteresis loop.

FIG. 19. FE simulations of the metacap. (A) Boundary conditions of the metacap simulations. (B) Stress distributions in the metacap (with tᵣ=10 mm, t_{c}=6 mm, Elite Double 32) before and after snapping. Unit: MPa.

FIG. 20. Our metacap grippers are capable of grasping objects with a wide range of shapes, moduli and weights. (A,B) The gripper made of Ecoflex 00-50 (Smooth-On Inc.) can grasp soft and delicate fruits like strawberries and grapes. (C,D) The gripper made of Elite Double 32 can capture objects of cuboid and conical shapes tightly. Scale bar, 30 mm.

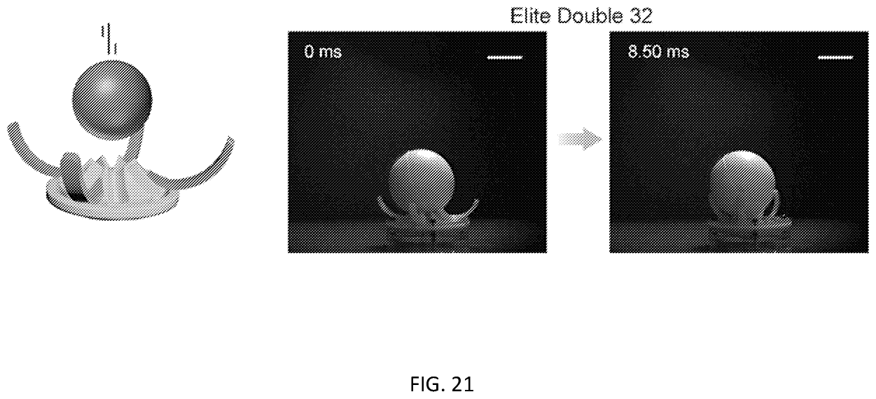

FIG. 21. Experimental measurements of the actuation speed of the passive gripper. The passive gripper made of Elite Double 32 can capture a stress ball within 8.5 ms after it hits on the center of the metacap. Scale bar, 30 mm.

FIG. 22. Our metacap gripper can mimic the a squirrel's paw when landing on a rod. (A) Squirrels can leap from one tree branch to another quickly and stably. In our experiments, the front paws of a squirrel take 10 ms to grasp on a rod after making contact with the rod. (B,C) The grippers made of (B) Elite Double 32 and (C) Flex 80 can grab the rod in 12 ms and 6.25 ms, respectively, after making contact to the rod. The modulus of the metacap shows an effect on the actuation speed of the gripper. The tests of the grippers are filmed with a high-speed camera (FASTCAM SA1.1, Photron) with 4000 frames per second (fps) to record the dynamic behaviors. Scale bar, 30 mm.

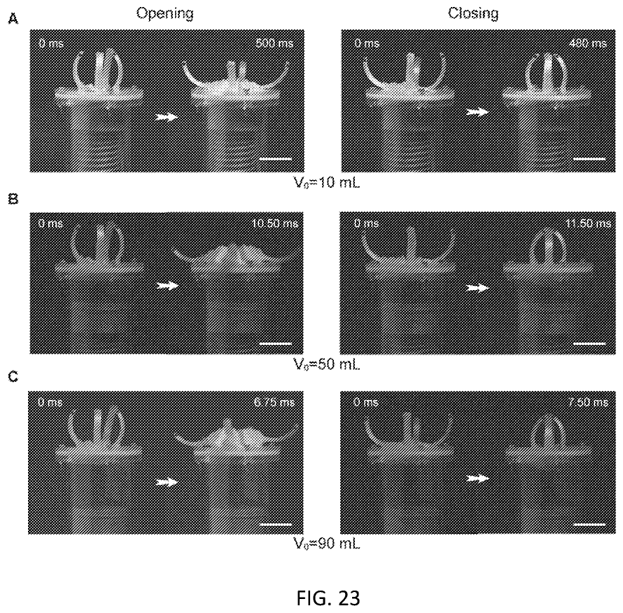

FIG. 23. Experimental snapshots of the opening and closing processes for the pneumatic actuators with different Initial volumes. (A) When the initial volume V₀=10 ml, the actuator takes 500 ms to open and 480 ms to close. (B) When the initial volume V₀=50 ml, the actuator takes 10.50 ms to open and 11.50 ms to close. (C) It only takes 6.75 ms for the actuator to open and 7.50 ms to close when V₀=90 ml. All actuators are inflated/deflated using the same pump (TSC JSB1523006) and the tests are filmed with a high-speed camera (FASTCAM SAL.1, Photron) to record the dynamic behavior. The frame rate of the camera is 1000, 2000 and 4000 frames per second (fps) for tests of V₀=10 ml, V₀=50 ml and V₀=90 ml, respectively. Scale bar, 30 mm.

FIG. 24. Model for the Closing process of the pneumatic gripper. (A) Pressure-volume curves of the metacap upon Inflation and deflation. During the closing process, the air inside the chamber absorbs energy (ΔEₐᵢᵣ=−20.2 mJ), which can be calculated from the area of the red shaded region. (B) The evolution of elastic energy as a function of the volume change Inside the chamber. The metacap release (ΔE_{cap}=130.7 mJ) elastic energy during the closing. (C) The total energy release versus the initial cavity of the chamber for the closing process of the gripper. Higher energy is released with larger V₀, which is experimentally validated by measuring the maximum speed of the finger tips.

### REFERENCES

1. Cianchetti, M., Laschi, C., Menciassi, A., Dario, P. Biomedical applications of soft robotics. Nat. Rev. Mater. 3, 143-153 (2018).
2. Wallin, T., Pikul, J., Shepherd, R. 3d printing of soft robotic systems. Nat. Rev. Mater. 3, 84-100 (2018).
3. Majidi, C. Soft-matter engineering for soft robotics. Adv. Mater. Technol. 4, 1800477 (2019).
4. Langowski, J., Sharma, P., Shoushtari, A. L. In the soft grip of nature. Sci. Robot. 5, eabd9120 (2020).
5. McCracken, J. M., Donovan, B. R., White, T. J. Materials as machines. Adv. Mater. 32, 1906564 (2020).
6. Rothemund, P., Kellaris, N., Mitchell, S. K., Acome, E., Keplinger, C. Hasel artificial muscles for a new generation of lifelike robots-recent progress and future opportunities. Adv. Mater. 33, 2003375 (2021).
7. Li, M., Pal, A., Aghakhani, A., Pena-Francesch, A., Sitti, M. Soft actuators for real-world applications. Nat. Rev. Mater. 7, 235-249 (2022).
8. Rothemund, P., Kim, Y., Heisser, R. H., Zhao, X., Shepherd, R. F., Keplinger, C. Shaping the future of robotics through materials innovation. Nat. Mater. 20, 1582-1587 (2021).
9. Ilievski, F., Mazzeo, A. D., Shepherd, R. F., Chen, X., Whitesides, G. M. Soft robotics for chemists. Angewandte Chemie 123, 1930-1935 (2011).
10. Whitesides, G. M. Soft robotics. Angewandte Chemie Int. Ed. 57, 4258-4273 (2018).
11. Jin, L., Forte, A. E., Bertoldi, K. Mechanical valves for on-board flow control of inflatable robots. Adv. Sci. 8, 2101941 (2021).
12. White, T. J., Broer, D. J. Programmable and adaptive mechanics with liquid crystal polymer networks and elastomers. Nat. Mater. 14, 1087-1098 (2015).
13. Wang, Y., Liu, J., Yang, S. Multi-functional liquid crystal elastomer composites. Appl. Phys. Rev. 9, 011301 (2022).
14. Lee, H., Xia, C., Fang, N. X. First jump of microgel; actuation speed enhancement by elastic instability. Soft Matter 6, 4342-4345 (2010).
15. Kim, Y., van den Berg, J., Crosby, A. J. Autonomous snapping and jumping polymer gels. Nat. Mater. 20, 1695-1701 (2021).
16. Kim, Y., Yuk, H., Zhao, R., Chester, S. A., Zhao, X. Printing ferromagnetic domains for untethered fast-transforming soft materials. Nature 558, 274-279 (2018).
17. Sîrbu, I.-D., Moretti, G., Bortolotti, G., Bolignari, M., Dirè, S., Fambri, L., Vertechy, R., Fontana, M. Electrostatic bellow muscle actuators and energy harvesters that stack up. Sci. Robot. 6, eaaz5796 (2021).
18. Diteesawat, R. S., Helps, T., Taghavi, M., Rossiter, J. Electro-pneumatic pumps for soft robotics. Sci. Robot. 6, eabc3721 (2021).
19. Pal, A., Restrepo, V., Goswami, D., Martinez, R. V. Exploiting mechanical instabilities in soft robotics: control, sensing, and actuation. Adv. Mater. 33, 2006939 (2021).
20. Chi, Y., Li, Y., Zhao, Y., Hong, Y., Tang, Y., Yin, J. Bistable and multistable actuators for soft robots: Structures, materials, and functionalities. Adv. Mater. 34, 2110384 (2022).
21. Thuruthel, T. G., Abidi, S. H., Cianchetti, M., Laschi, C., Falotico, E. A bistable soft gripper with mechanically embedded sensing and actuation for fast grasping. In 2020 29th IEEE International Conference on Robot and Human Interactive Communication (RO-MAN), 1049-1054 (IEEE, 2020).
22. Tang, Y., Chi, Y., Sun, J., Huang, T.-H., Maghsoudi, O. H., Spence, A., Zhao, J., Su, H., Yin, J. Leveraging elastic instabilities for amplified performance: Spine-inspired high-speed and high-force soft robots. Sci. Adv. 6, eaaz6912 (2020).
23. Lin, Y., Zhang, C., Tang, W., Jiao, Z., Wang, J., Wang, W., Zhong, Y., Zhu, P., Hu, Y., Yang, H. et al. A bioinspired stress-response strategy for high-speed soft grippers. Adv. Sci. 8, 2102539 (2021).
24. Liu, Y., Luo, K., Wang, S., Song, X., Zhang, Z., Tian, Q., Hu, H. A soft and bistable gripper with adjustable energy barrier for fast capture in space. Soft Robot. (2022).
25. Gorissen, B., Melancon, D., Vasios, N., Torbati, M., Bertoldi, K. Inflatable soft jumper inspired by shell snapping. Sci. Robot. 5, eabb1967 (2020).
26. Qiao, C., Liu, L., Pasini, D. Bi-shell valve for fast actuation of soft pneumatic actuators via shell snapping interaction. Adv. Sci. 8, 2100445 (2021).
27. Shan, S., Kang, S. H., Raney, J. R., Wang, P., Fang, L., Candido, F., Lewis, J. A., Bertoldi, K. Multistable architected materials for trapping elastic strain energy. Adv. Mater. 27, 4296-4301 (2015).
28. Yuan, S., Chua, C. K., Zhou, K. 3d-printed mechanical metamaterials with high energy absorption. Adv. Mater. Technol. 4, 1800419 (2019).
29. Zanaty, M., Fussinger, T., Rogg, A., Lovera, A., Lambelet, D., Vardi, I., Wolfensberger, T. J., Baur, C., Henein, S. Programmable multistable mechanisms for safe surgical puncturing. J. Med. Devices 13 (2019).
30. Li, M., Tang, Y., Soon, R. H., Dong, B., Hu, W., Sitti, M. Miniature coiled artificial muscle for wireless soft medical devices. Sci. Adv. 8, eabm5616 (2022).
31. Chen, T., Bilal, O. R., Shea, K., Daraio, C. Harnessing bistability for directional propulsion of soft, untethered robots. Proc. Natl. Acad. Sci. 115, 5698-5702 (2018).
32. Rothemund, P., Ainla, A., Belding, L., Preston, D. J., Kurihara, S., Suo, Z., Whitesides, G. M. A soft, bistable valve for autonomous control of soft actuators. Sci. Robot. 3, eaar7986 (2018).
33. Wagner, H., Huhne, C., Niemann, S. Robust knockdown factors for the design of spherical shells under external pressure: Development and validation. Int. J. Mech. Sci. 141, 58-77 (2018).
34. Hunt, N. H., Jinn, J., Jacobs, L. F., Full, R. J. Acrobatic squirrels learn to leap and land on tree branches without falling. Science 373, 697-700 (2021).
35. Brown, E., Rodenberg, N., Amend, J., Mozeika, A., Steltz, E., Zakin, M. R., Lipson, H., Jaeger, H. M. Universal robotic gripper based on the jamming of granular material. Proc. Natl. Acad. Sci. 107, 18809-18814 (2010).
36. Mosadegh, B., Polygerinos, P., Keplinger, C., Wennstedt, S., Shepherd, R. F., Gupta, U., Shim, J., Bertoldi, K., Walsh, C. J., Whitesides, G. M. Pneumatic networks for soft robotics that actuate rapidly. Adv. Funct. Mater. 24, 2163-2170 (2014).
37. Sinatra, N. R., Teeple, C. B., Vogt, D. M., Parker, K. K., Gruber, D. F., Wood, R. J. Ultragentle manipulation of delicate structures using a soft robotic gripper. Sci. Robot. 4, eaax5425 (2019).
38. Bas, O., Gorissen, B., Luposchainsky, S., Shabab, T., Bertoldi, K., Hutmacher, D. W. Ultrafast, miniature soft actuators. Multifunct. Mater. 4, 045001 (2021).
39. Acome, E., Mitchell, S. K., Morrissey, T., Emmett, M., Benjamin, C., King, M., Radakovitz, M., Keplinger, C. Hydraulically amplified self-healing electrostatic actuators with muscle-like performance. Science 359, 61-65 (2018).
40. Baumgartner, R., Kogler, A., Stadlbauer, J. M., Foo, C. C., Kaltseis, R., Baumgartner, M., Mao, G., Keplinger, C., Koh, S. J. A., Arnold, N. et al. A lesson from plants: high-speed soft robotic actuators. Adv. Sci. 7, 1903391 (2020).
41. Wang, Y., Gupta, U., Parulekar, N., Zhu, J. A soft gripper of fast speed and low energy consumption. Sci. China Technol. Sci. 62, 31-38 (2019).
42. Wang, X., Mao, G., Ge, J., Drack, M., Cañón Bermúdez, G. S., Wirthl, D., Illing, R., Kosub, T., Bischoff, L., Wang, C. et al. Untethered and ultrafast soft-bodied robots. Commun. Mater. 1, 1-10 (2020).
43. Kim, S.-W., Koh, J.-S., Cho, M., Cho, K.-J. Towards a bio-mimetic flytrap robot based on a snap-through mechanism. In 2010 3rd IEEE RAS & EMBS International Conference on Biomedical Robotics and Biomechatronics, 534-539 (IWEE, 2010).
44. He, Q., Wang, Z., Wang, Y., Minori, A., Tolley, M. T., Cai, S. Electrically controlled liquid crystal elastomer-based soft tubular actuator with multimodal actuation. Sci. Adv. 5, eaax5746 (2019).
45. Preston, D. J., Jiang, H. J., Sanchez, V., Rothemund, P., Rawson, J., Nemitz, M. P., Lee, W.-K., Suo, Z., Walsh, C. J., Whitesides, G. M. A soft ring oscillator. Sci. Robot. 4, eaaw5496 (2019).
46. Lee, W.-K., Preston, D. J., Nemitz, M. P., Nagarkar, A., MacKeith, A. K., Gorissen, B., Vasios, N., Sanchez, V., Bertoldi, K., Mahadevan, L. et al. A buckling-sheet ring oscillator for electronics-free, multimodal locomotion. Sci. Robot. 7, eabg5812 (2022).
47. van Laake, L. C., de Vries, J., Kani, S. M., Overvelde, J. T. A fluidic relaxation oscillator for reprogrammable sequential actuation in soft robots. Matter (2022).
48. Goçcalves, P. B., Pamplona, D., Teixeira, P. B., Jerusalmi, R. L., Cestari, I. A., Leirner, A. A. Dynamic non-linear behavior and stability of a ventricular assist device. Int. J. Solids Struct. 40, 5017-5035 (2003).
49. Timms, D. A review of clinical ventricular assist devices. Med. Eng. & Phys. 33, 1041-1047 (2011).
50. Drotman, D., Jadhav, S., Sharp, D., Chan, C., Tolley, M. T. Electronics-free pneumatic circuits for controlling soft-legged robots. Sci. Robot. 6, eaay2627 (2021).
51. Hong, C., Ren, Z., Wang, C., Li, M., Wu, Y., Tang, D., Hu, W., Sitti, M. Magnetically actuated gearbox for the wireless control of millimeter-scale robots. Sci. Robot. 7, eabo4401 (2022).
52. Senn, M. Digital image correlation and tracking (https://www.mathworks.com/matlabcentral/fileexchange/50994-digital-image-correlation-and-tracking). MATLAB Cent. File Exch. Retrieved Aug. 31, 2022.

### Aspects

The following Aspects are illustrative only and do not limit the scope of the present disclosure or the appended claims. Any part or parts of any one or more Aspects can be combined with any part or parts of any one or more other Aspects.
Aspect 1. A component, comprising: a cap, the cap optionally being a spherical cap, the cap having a first surface and a second surface, the cap being reversibly convertible between (i) a first state in which the first surface is concave and the second surface is convex and (ii) a second state in which the first surface is convex and the second surface is concave, at least one of the first state and the second state being a stable state, the cap defining a center, the first surface comprising a plurality of radially-extending ribs extending outwardly from a central axis that extends from the center of the cap and orthogonal to the first surface, a radially extending rib having an end at a radial distance from the center, a radially-extending rib being optionally being substantially sector-shaped in configuration and widening as measured in a radial direction away from the center, the first surface further comprising a circumferentially extending rib.
Aspect 2. The component of claim 1, wherein the cap defines a radius R when in the first state, wherein the cap defines a thickness t, and wherein t/R is in the range of from about 0.01 to about 0.15.
Aspect 3. The component of any one of claims 1-2, wherein a radially extending rib defines a polar angle φᵣ of from about 25 to about 40 degrees measured relative to the central axis when the cap is in the first state, the component optionally comprising from 6 to 16 radial ribs, preferably 8 radial ribs. A polar angle is shown in FIG. 1.
Aspect 4. The component of any one of claims 1-3, wherein a radially extending rib defines an azimuthal angle θᵣ of from about 5 to about 80 degrees measured relative to the central axis when the cap is in the first state. An azimuthal angle is shown in FIG. 1.
Aspect 5. The component of any one of claims 1-4, wherein the circumferentially extending rib defines a polar angle φ_{c} of from about 0 to about 45 degrees measured relative to the central axis when the cap is in the first state. A polar angle is shown in FIG. 1.
Aspect 6. The component of any one of claims 1-5, wherein the cap defines a polar angle φ of from about 10 to about 85 degrees measured relative to the central axis when the cap is in the first state. A polar angle is shown in FIG. 1.
Aspect 7. The component of any one of claims 1-6, wherein the first state is a stable state and the second state is a stable state.
Aspect 8. The component of claim 7, further comprising a plurality of grippers extending outwardly from the first surface. An example component is shown in FIG. 2.
Aspect 9. The component of any one of claims 7-8, wherein the second surface of the cap is in fluid communication with an actuator that is in mechanical communication with a fin, a propeller, or both. Example components are shown in FIGS. 4-5.
Aspect 10. The component of any one of claims 1-6, wherein the first state is a monostable state.
Aspect 11. The component of claim 10, wherein the cap comprises an aperture extending therethrough and the component further comprises a membrane configured such that the aperture is occluded by the membrane when the cap is in the first state and the aperture is free of the membrane when the cap is in the second state. An example such component is shown in FIG. 5.
Aspect 12. A system, comprising: a component of any one of claims 1-11; and a force applicator configured to exert a positive pressure or a negative pressure against the second surface of the cap so as to encourage the cap from one of the first state and the second state toward the other of the first state and the second state.
Aspect 13. The system of claim 12, wherein the force applicator comprises a pneumatic component.
Aspect 14. The system of claim 13, wherein the pneumatic component comprises a chamber having a volume in fluid communication with the second surface of the component, the volume of the chamber optionally being adjustable.
Aspect 15. The system of claim 12, wherein the force applicator comprises a linear actuator.
Aspect 16. A method, comprising: with a component according to any one of claims 1-11, exerting a positive pressure or a negative pressure against the second surface of the cap so as to encourage the cap from one of the first state and the second state toward the other of the first state and the second state.
Aspect 17. The method of claim 16, wherein the exerting is effected so as to effect gripping of an object by the component.
Aspect 18. The method of claim 16, wherein the exerting is effected so as to effect release of an object gripped by the component.
Aspect 19. The method of claim 16, wherein the exerting is effected so as to regulate the performance of an actuator in fluid communication with the cap.
Aspect 20. The method of any one of claims 16-19, wherein the positive pressure or negative pressure is exerted by a pneumatic component that defines a chamber having a volume in fluid communication with the second surface of the cap, the volume of the chamber optionally being adjustable.
Aspect 21. The method of claim 20, further comprising adjusting the volume of the chamber.

1. A component, comprising:
a cap,
the cap optionally being a spherical cap,
the cap having a first surface and a second surface,
the cap being reversibly convertible between (i) a first state in which the first surface is concave and the second surface is convex and (ii) a second state in which the first surface is convex and the second surface is concave,
at least one of the first state and the second state being a stable state,
the cap defining a center,
the first surface comprising a plurality of radially-extending ribs extending outwardly from a central axis that extends from the center of the cap and orthogonal to the first surface,
a radially extending rib having an end at a radial distance from the center,
a radially-extending rib being optionally being substantially sector-shaped in configuration and widening as measured in a radial direction away from the center,
the first surface further comprising a circumferentially extending rib.

2. The component of claim 1, wherein the cap defines a radius R when in the first state, wherein the cap defines a thickness t, and wherein t/R is in the range of from about 0.01 to about 0.15.

3. The component of claim 1, wherein a radially extending rib defines a polar angle φᵣ of from about 25 to about 40 degrees measured relative to the central axis when the cap is in the first state, the component optionally comprising from 6 to 16 radial ribs, preferably 8 radial ribs.

4. The component of claim 1, wherein a radially extending rib defines an azimuthal angle θᵣ of from about 5 to about 80 degrees measured relative to the central axis when the cap is in the first state.

5. The component of claim 1, wherein the circumferentially extending rib defines a polar angle φ_{c} of from about 0 to about 45 degrees measured relative to the central axis when the cap is in the first state.

6. The component of claim 1, wherein the cap defines a polar angle φ of from about 10 to about 85 degrees measured relative to the central axis when the cap is in the first state.

7. The component of claim 1, wherein the first state is a stable state and the second state is a stable state.

8. The component of claim 7, further comprising a plurality of grippers extending outwardly from the first surface.

9. The component of claim 7, wherein the second surface of the cap is in fluid communication with an actuator that is in mechanical communication with a fin, a propeller, or both.

10. The component of claim 1, wherein the first state is a monostable state.

11. The component of claim 10, wherein the cap comprises an aperture extending therethrough and the component further comprises a membrane configured such that the aperture is occluded by the membrane when the cap is in the first state and the aperture is free of the membrane when the cap is in the second state.

12. A system, comprising:
a component of claim 1; and
a force applicator configured to exert a positive pressure or a negative pressure against the second surface of the cap so as to encourage the cap from one of the first state and the second state toward the other of the first state and the second state.

13. The system of claim 12, wherein the force applicator comprises a pneumatic component.

14. The system of claim 13, wherein the pneumatic component comprises a chamber having a volume in fluid communication with the second surface of the component, the volume of the chamber optionally being adjustable.

15. The system of claim 12, wherein the force applicator comprises a linear actuator.

16. A method, comprising:
with a component according to claim 1,
exerting a positive pressure or a negative pressure against the second surface of the cap so as to encourage the cap from one of the first state and the second state toward the other of the first state and the second state.

17. The method of claim 16, wherein the exerting is effected so as to effect gripping of an object by the component.

18. The method of claim 16, wherein the exerting is effected so as to effect release of an object gripped by the component.

19. The method of claim 16, wherein the exerting is effected so as to regulate performance of an actuator in fluid communication with the cap.

20. The method of claim 16, wherein the positive pressure or negative pressure is exerted by a pneumatic component that defines a chamber having a volume in fluid communication with the second surface of the cap, the volume of the chamber optionally being adjustable, and optionally adjusting the volume of the chamber.

21. (canceled)
